(19) United States
(12) Patent Application Publication
(10) Pub. No.: US 2016/0167513 A1
(43) Pub. Date: Jun. 16, 2016

(54) INFORMATION PROCESSING APPARATUS, INFORMATION DISPLAY APPARATUS, AND DISPLAY CONTROL METHOD

(71) Applicant: MITSUBISHI ELECTRIC CORPORATION, Tokyo (JP)

(72) Inventors: Hidekazu ARITA, Tokyo (JP); Mitsuo SHIMOTANI, Tokyo (JP)

(73) Assignee: MITSUBISHI ELECTRIC CORPORATION, Tokyo (JP)

(21) Appl. No.: 14/904,055

(22) PCT Filed: Sep. 10, 2013
(86) PCT No.: PCT/JP2013/074330

§ 371 Date: Jan. 8, 2016

(51) Int. Cl. B60K 35/00

(52) U.S. Cl. CPC B60K 35/00; B60K 2350/2008; B60K 2350/352; B60K 2350/1072

(57) ABSTRACT

An information processing apparatus includes a speed-related information acquirer and a controller. The speed-related information acquirer acquires, as speed-related information, information on a travel speed of a moving object or two pieces of information on the travel speed and on a speed limit for a road on which the moving object is located. The controller controls, in accordance with the speed-related information, a display manner of a speedometer region on a screen. The speedometer region includes a speedometer that displays the travel speed and a background region of the speedometer. The background region includes a base region and a notification region in which a color different from that of the base region is predominant.

### TECHNICAL FIELD

The present invention relates to an information processing apparatus, an information display apparatus, and a display control method.

### BACKGROUND ART

The technique related to the displaying of speedometers for vehicles is disclosed in Patent Document 1 mentioned below. For example, the display size of the speedometer is determined within a range of the small display size to the large display size depending on the traveling speed. Thus, the display size of the speedometer is large while the vehicle is traveling at high speed. Besides the display size, the display contrast, the display shape, and the display position are described as examples. For example, the display position of the speedometer is brought closer to the reference position as the traveling speed increases.

### PRIOR ART DOCUMENT

### Patent Document

Patent Document 1: Japanese Patent Application Laid-Open No. 2012-154749

### SUMMARY OF INVENTION

### Problems to be Solved by the Invention

The technique according to Patent Document 1 presumably increases the viewability of the speedometer (facilitates the visual recognition of the speedometer) particularly during the high-speed traveling. However, for the driver looking at the speedometer, the vehicle speed alone is the information available on the speedometer.

In a case where a large number of measuring instruments and alarm lights are located on the instrument panel, the driver looking at the speedometer focuses attention to the speedometer being the object of observation, thus paying relatively little attention to other measuring instruments. In other words, the vision is substantially narrowed to the field occupied by the speedometer.

The same holds true for the case where an alarm light and the like are located inside the pointer display speedometer. That is, the driver trying to find out the vehicle speed gives attention to the portion around the tip of the pointer of the speedometer, and thus, the alarm light is out of the driver's actual view. When the driver looks at the alarm light inside the speedometer, meanwhile, the driver's actual view moves to the position of the alarm light. Presumably, this is because the driver recognizes the alarm light and the speedometer as two different objects.

The present invention has an object to refine the display region of a speedometer, thereby providing the speed information and the information other than the speed information in an integrated manner and thus resulting in, for example, improved convenience.

### Means to Solve the Problems

An information processing apparatus according to an aspect of the present invention includes a speed-related information acquiring unit and a controller. The speed-related information acquiring unit acquires, as speed-related information, information on a travel speed of a moving object or two pieces of information on the travel speed and on a speed limit for a road on which the moving object is located. The controller controls, in accordance with the speed-related information, a display manner of a speedometer region on a screen. The speedometer region includes a speedometer that displays the travel speed and a background region of the speedometer. The background region includes a base region and a notification region in which a color different from that of the base region is predominant.

### Effects of the Invention

According to the above-mentioned aspect, the display manner of the speedometer region allows the travel speed displayed on the speedometer and other pieces of information corresponding to speed-related information to be provided in an integrated manner. Thus, a user can obtain not only the travel speed but also the information other than the travel speed by looking at the speedometer region. This results in, for example, improved convenience.

These and other objects, features and advantages of the present invention will become more apparent from the following detailed description of the present invention when taken in conjunction with the accompanying drawings.

### BRIEF DESCRIPTION OF DRAWINGS

FIG. 1 An explanatory diagram describing a screen of an information display apparatus in an embodiment 1.

FIG. 2 An explanatory diagram describing a first example of a speedometer region in the embodiment 1.

FIG. 3 An explanatory diagram describing a first example of control over a display manner of the speedometer region (control over a background region) in the embodiment 1.

FIG. 4 An explanatory diagram describing a second example of control over the display manner of the speedometer region (control over the background region) in the embodiment 1.

FIG. 5 An explanatory diagram describing a second example of the speedometer region in the embodiment 1.

FIG. 6 An explanatory diagram describing a third example of control over the display manner of the speedometer region (control over the background region) in the embodiment 1.

FIG. 7 An explanatory diagram describing a fourth example of control over the display manner of the speedometer region (setting of the height of a notification region) in the embodiment 1.

FIG. 8 An explanatory diagram describing a fifth example of control over the display manner of the speedometer region (continuous changes in the shape of the notification region) in the embodiment 1.

FIG. 9 An explanatory diagram describing a sixth example of control over the display manner of the speedometer region (discontinuous changes in the shape of the notification region) in the embodiment 1.

FIG. 10 A block diagram describing the information display apparatus and an information processing apparatus in the embodiment 1.

FIG. 11 A flowchart describing the operation of the information processing apparatus in the embodiment 1.

FIG. 12 An explanatory diagram describing a third example of the speedometer region in an embodiment 2.

FIG. 13 An explanatory diagram describing a fourth example of the speedometer region in the embodiment 2.

FIG. 14 An explanatory diagram describing a seventh example of control over the display manner of the speedometer region (control over the background region) in an embodiment 3.

FIG. 15 An explanatory diagram describing an eighth example of control over the display manner of the speedometer region (control over the background region) in the embodiment 3.

FIG. 16 An explanatory diagram describing a ninth example of control over the display manner of the speedometer region (control over the background region) in the embodiment 3.

FIG. 17 An explanatory diagram describing a tenth example of control over the display manner of the speedometer region (control over the background region) in the embodiment 3.

FIG. 18 An explanatory diagram describing an eleventh example of control over the display manner of the speedometer region (control over the background region) in the embodiment 3.

FIG. 19 An explanatory diagram describing a twelfth example of control over the display manner of the speedometer region (control over the background region) in the embodiment 3.

FIG. 20 An explanatory diagram describing a fifth example of the speedometer region in an embodiment 4.

FIG. 21 An explanatory diagram describing a thirteenth example of control over the display manner of the speedometer region (control over the background region) in an embodiment 5.

FIG. 22 An explanatory diagram describing a fourteenth example of control over the display manner of the speedometer region (control over the background region) in the embodiment 5.

FIG. 23 An explanatory diagram describing a fifteenth example of control over the display manner of the speedometer region (control over the background region) in the embodiment 5.

FIG. 24 An explanatory diagram describing a sixteenth example of control over the display manner of the speedometer region (control over the background region) in the embodiment 5.

FIG. 25 An explanatory diagram describing a seventeenth example of control over the display manner of the speedometer region (control over the background region) in the embodiment 5.

FIG. 26 An explanatory diagram describing an eighteenth example of control over the display manner of the speedometer region (control over the background region) in the embodiment 5.

FIG. 27 An explanatory diagram describing a nineteenth example of control over the display manner of the speedometer region (control over the background region) in the embodiment 5.

FIG. 28 A block diagram describing the information display apparatus and the information processing apparatus in the embodiment 5.

FIG. 29 A flowchart describing the operation of the information processing apparatus in the embodiment 5.

FIG. 30 An explanatory diagram describing a twentieth example of control over the display manner of the speedometer region (control over the display position of the speedometer) in an embodiment 6.

FIG. 31 An explanatory diagram describing a twenty-first example of control over the display manner of the speedometer region (control over the display position of the speedometer) in the embodiment 6.

FIG. 32 An explanatory diagram describing a twenty-second example of control over the display manner of the speedometer region (control over the display manner of the speedometer) in an embodiment 7.

FIG. 33 An explanatory diagram describing a twenty-third example of control over the display manner of the speedometer region (control over the display manner of the speedometer) in the embodiment 7.

FIG. 34 An explanatory diagram describing a twenty-fourth example of control over the display manner of the speedometer region (control over the display manner of the speedometer) in the embodiment 7.

FIG. 35 An explanatory diagram describing a twenty-fifth example of control over the display manner of the speedometer region (control over the display manner of the speedometer) in an embodiment 8.

FIG. 36 An explanatory diagram describing a twenty-sixth example of control over the display manner of the speedometer region (control over the display manner of the speedometer) in the embodiment 8.

FIG. 37 An explanatory diagram describing a twenty-seventh example of control over the display manner of the speedometer region in an embodiment 9.

FIG. 38 An explanatory diagram describing a twenty-eighth example of control over the display manner of the speedometer region in the embodiment 9.

FIG. 39 An explanatory diagram describing a twenty-ninth example of control over the display manner of the speedometer region in the embodiment 9.

FIG. 40 An explanatory diagram describing a thirtieth example of control over the display manner of the speedometer region in the embodiment 9.

FIG. 41 An explanatory diagram describing a thirty-first example of control over the display manner of the speedometer region in the embodiment 9.

FIG. 42 An explanatory diagram describing a thirty-second example of control over the display manner of the speedometer region in the embodiment 9.

FIG. 43 An explanatory diagram describing a thirty-third example of control over the display manner of the speedometer region in the embodiment 9.

FIG. 44 An explanatory diagram describing a thirty-fourth example of control over the display manner of the speedometer region in the embodiment 9.

FIG. 45 An explanatory diagram describing a first example of a display apparatus in an embodiment 10.

FIG. 46 An explanatory diagram describing a second example of the display apparatus in the embodiment 10.

FIG. 47 An explanatory diagram describing a third example of the display apparatus in the embodiment 10.

FIG. 48 An explanatory diagram describing a fourth example of the display apparatus in the embodiment 10.

FIG. 49 An explanatory diagram describing a fifth example of the display apparatus in the embodiment 10.

FIG. 50 A block diagram describing the information display apparatus and the information processing apparatus in an embodiment 11.

FIG. 51 A flowchart describing the operation of the information processing apparatus in the embodiment 11.

FIG. 52 A block diagram describing the information display apparatus and the information processing apparatus in an embodiment 12.

FIG. 53 A flowchart describing the operation of the information processing apparatus in the embodiment 12.

FIG. 54 An explanatory diagram describing a thirty-fifth example of control over the display manner of the speedometer region (control over the background region) in the embodiment 12.

FIG. 55 An explanatory diagram describing a thirty-sixth example of control over the display manner of the speedometer region (control over the background region) in the embodiment 12.

FIG. 56 An explanatory diagram describing a thirty-seventh example of control over the display manner of the speedometer region (control over the background region) in the embodiment 12.

FIG. 57 An explanatory diagram describing a thirty-eighth example of control over the display manner of the speedometer region (control over the background region) in the embodiment 12.

FIG. 58 An explanatory diagram describing a thirty-ninth example of control over the display manner of the speedometer region (control over the background region) in the embodiment 12.

FIG. 59 An explanatory diagram describing a fortieth example of control over the display manner of the speedometer region (control over the background region) in the embodiment 12.

FIG. 60 An explanatory diagram describing a forty-first example of control over the display manner of the speedometer region (control over the speedometer) in the embodiment 12.

FIG. 61 An explanatory diagram describing a forty-second example of control over the display manner of the speedometer region (control over the speedometer) in the embodiment 12.

FIG. 62 An explanatory diagram describing a forty-third example of control over the display manner of the speedometer region (control over the speedometer) in the embodiment 12.

FIG. 63 An explanatory diagram describing a forty-fourth example of control over the display manner of the speedometer region (control over the speedometer) in the embodiment 12.

FIG. 64 An explanatory diagram describing a forty-fifth example of control over the display manner of the speedometer region (control over the background region) in the embodiment 12.

FIG. 65 An explanatory diagram describing a forty-sixth example of control over the display manner of the speedometer region in the embodiment 12.

### DESCRIPTION OF EMBODIMENTS

In the following embodiments is described an example case in which an information processing apparatus and an information display apparatus according to the present invention are installed in a vehicle being one example of moving bodies. Note that the present invention is not limited to this example as mentioned below.

### Embodiment 1

### Summary of Speedometer Region

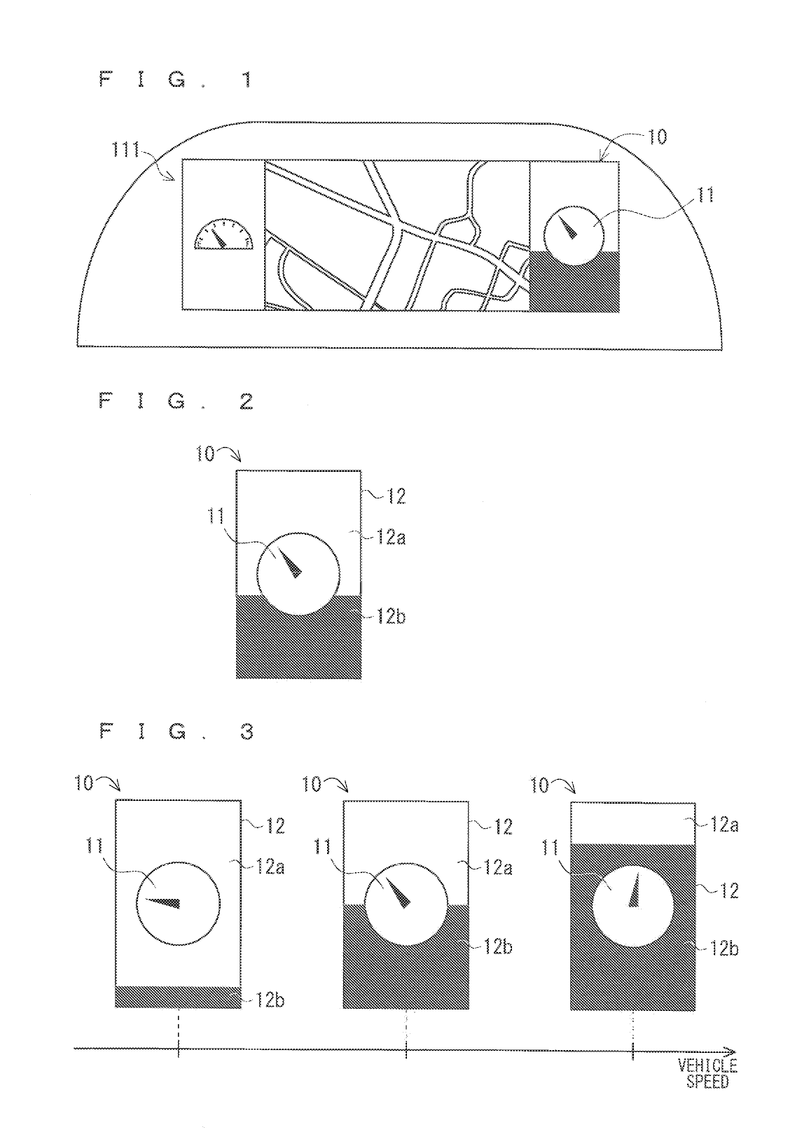

FIG. 1 illustrates the screen of an information display apparatus according to an embodiment 1. The screen refers to the surface on which information is provided in visual form. The screen is not limited to the plane surface.

In the example shown in FIG. 1, a screen 111, which is located in front of the driver's seat, provides an integrated instrument panel. The integrated instrument panel is the display panel capable of displaying, in an integrated manner, for example, meters (such as a speedometer and a tachometer), various kinds of alarms, a navigation image, operation conditions of various kinds of apparatuses (such as audio-visual (AV) equipment), and a video image taken by a vehicle-installed camera. The integrated instrument panel is also referred to as, for example, an integrated dashboard and a meter cluster. Although not shown in the drawings, alarm lights and pilot lights are also located.

In the integrated instrument panel, information of one kind or some kinds is laid out and displayed. The information to be displayed can be switched. The panel may be configured such that a user can lay out and switch information. In the example shown in FIG. 1, a map is displayed in the midsection of the screen 111, a fuel gauge is displayed on the left side of the screen 111, and a speedometer 11 is displayed on the right side of the screen 111.

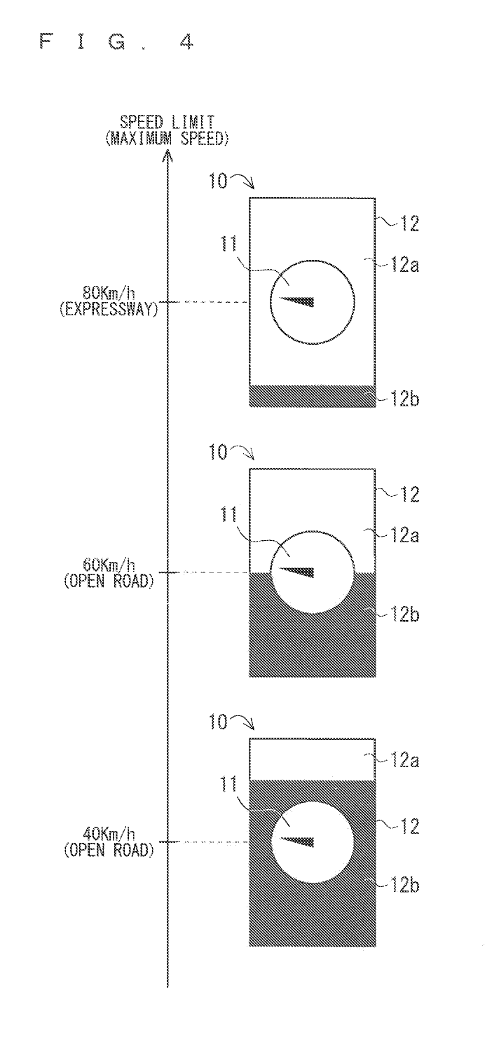

In particular, the speedometer 11 is displayed as a speedometer region 10. FIG. 2 illustrates the speedometer region 10. The speedometer region 10 essentially includes the speedometer 11 and a background region 12 of the speedometer 11. The speedometer 11 displays the vehicle speed (in other words, the travel speed of a moving object) and the entirety of the speedometer 11 is located within the background region 12. The speedometer 11 illustrated in, for example, FIG. 2 is a pointer display speedometer. Alternatively, the speedometer 11 may be a numerical display speedometer.

In the example shown in FIG. 2, the background region 12 includes a base region 12a and a notification region 12b. The base region 12a is located on the upper side of the background region 12 and the notification region 12b is located on the lower side of the background region 12.

The base region 12a is the region in which a preset color is predominant. The notification region 12b is the region in which a color different from that of the base region 12a is predominant. In this example, the color of the base region 12a is black and the color of the notification region 12b is red. The colors of the base region 12a and the notification region 12b are not limited to the above example. The color of the base region 12a may be unchangeable or may be changeable. The same holds true for the color of the notification region 12b.

The notification region 12b is intended to provide a notification to a user (such as a driver). In the embodiment 1, the notification region 12b is used as the region for providing a notification to call attention to the vehicle speed. Thus, a conspicuous color is preferably applied to the notification region 12b. In this respect, the example of the notification 12b in red agrees with the general sense. The color of the notification region 12b can contrast with the color of the base region 12a. In general, a color has three elements: hue, saturation, and lightness. At least one of these three elements differentiates one color from another color. The difference in color is likely to be more conspicuous especially when there is a difference in hue.

For the purpose of brevity of the drawings, the base region 12a and the notification region 12b have no patterns. However, the designs of the base region 12a and the notification region 12b are not limited to this example.

<Change in Shape of Notification Region 12b>

In the embodiment 1, the shape of the notification region 12b changes in accordance with at least one of the vehicle speed (or equivalently, the travel speed of the vehicle) and the speed limit for the road on which the vehicle is located. In the embodiment 1, the display position of the speedometer 11 does not change and is fixed to, for example, the midsection of the background region 12.

Firstly, FIG. 3 shows an example of the notification region 12b that changes its shape in accordance with the vehicle speed. In this example, the dimension of the notification region 12b in the preset direction increases with increasing vehicle speed. In other words, the dimension of the notification region 12b in the above-mentioned direction decreases with decreasing vehicle speed. Thus, the notification region 12b is extended and contracted in the above-mention direction in accordance with the vehicle speed. The shape and the dimension of the background region 12 as a whole do not change, and thus, the base region 12a is reduced as the notification region 12b is expanded.

In this example, the notification region 12b is extended and contracted in the vertical direction of the background region 12, or equivalently, in the vertical direction of the screen 111 (see FIG. 1). In the example shown in FIG. 3, the shorter side of the background region 12 is set at the top, and thus, the longitudinal direction of the background region 12 corresponds to the vertical direction of the screen 111.

The vertical direction may be also referred to as a height direction and the horizontal direction may be also referred to as a width direction. The dimension in the vertical direction may be also referred to as a height dimension or a height and the dimension in the horizontal direction may be also referred to as a width dimension or a width.

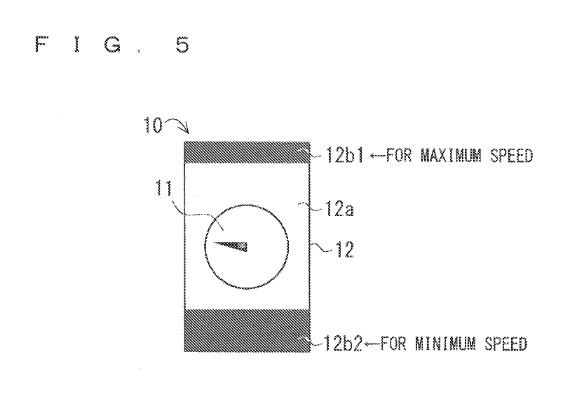

FIG. 4 shows an example of the notification region 12b that changes its shape in accordance with the speed limit for the road on which the vehicle is located. The speed limit refers to, for example, the legally permitted speed. In a case where the legally permitted speed is revised depending on, for example, the time of day, the weather, traffic conditions, and the holding of events, the revised speed is regarded as the legally permitted speed. The speed limit refers to two kinds of speed being the maximum speed and the minimum speed. In many cases, only the maximum speed is set for open roads. Meanwhile, the maximum speed and the minimum speed are principally set for, for example, expressways.

The example shown in FIG. 4 describes the case in which the speed limit refers to the maximum speed, and thus, the height of the notification region 12b decreases with increasing maximum speed even if the vehicle speed is equal. In a case where the speed limit refers to the minimum speed, meanwhile, the height of the notification region 12b increases with increasing minimum speed even if the vehicle speed is equal.

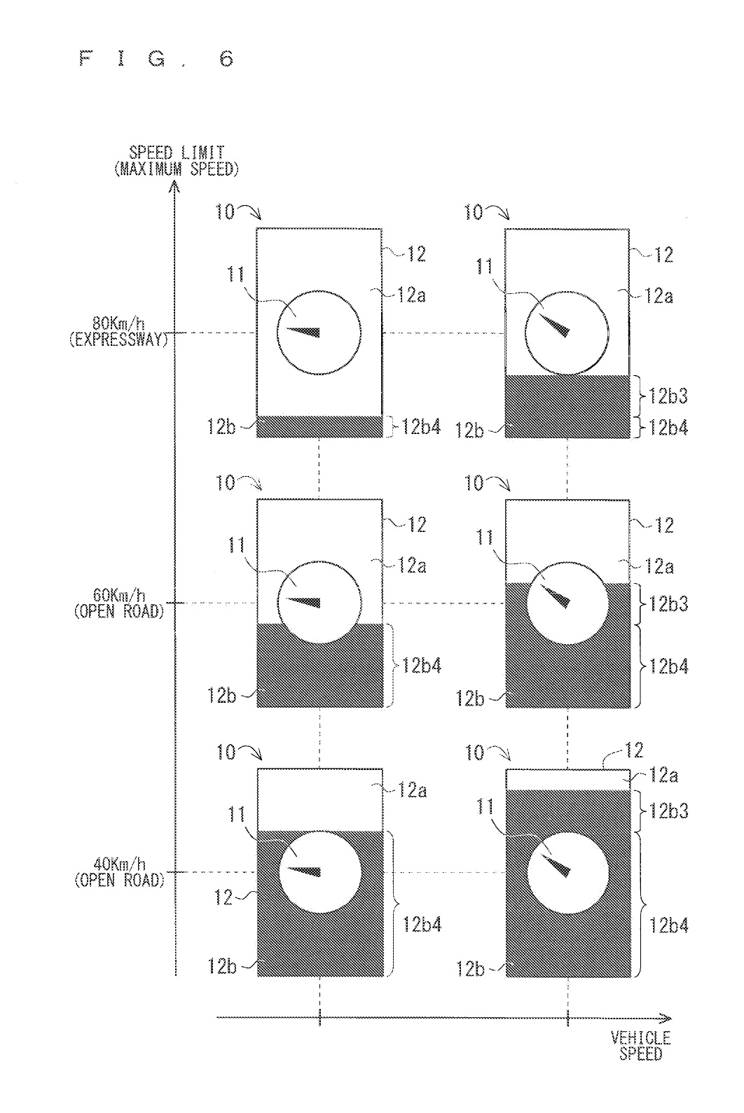

As illustrated in FIG. 5, a notification region 12b1 for the maximum speed may be provided on the upper side of the background region 12 and a notification region 12b2 for the minimum speed may be provided on the lower side of the background region 12. Each of the shape of the notification region 12b1 and the shape of the notification region 12b2 may be changed.

FIG. 6 shows the example of the notification region 12b that changes its shape in accordance with both the vehicle speed and the speed limit. In this example, the notification region 12b includes a travel speed associated section 12b3 and a speed limit associated section 12b4. As with the example in FIG. 3, the shape of the travel speed associated section 12b3 is changed in accordance with the vehicle speed. As with the example in FIG. 4, the shape of the speed limit associated section 12b4 is changed in accordance with the speed limit (the maximum speed in this example). FIG. 6 schematically illustrates the travel speed associated section 12b3 and the speed limit associated section 12b4 but does not limit, for example, the positions of these sections 12b3 and 12b4.

The shape of the speed limit associated section 12b4 may be changed in accordance with the minimum speed. Following the example in FIG. 5, the two notification regions 12b1 and 12b2 may be provided. The shape of the notification region 12b1 for the maximum speed may be changed in accordance with both the vehicle speed and the maximum speed. The shape of the notification region 12b2 for the minimum speed may be changed in accordance with both the vehicle speed and the minimum speed.

With reference to the examples in FIGS. 3 to 6, the area of the notification region 12b increases as the height of the notification region 12b increases. Conversely, the area of the notification region 12b decreases as the height of the notification region 12b decreases.

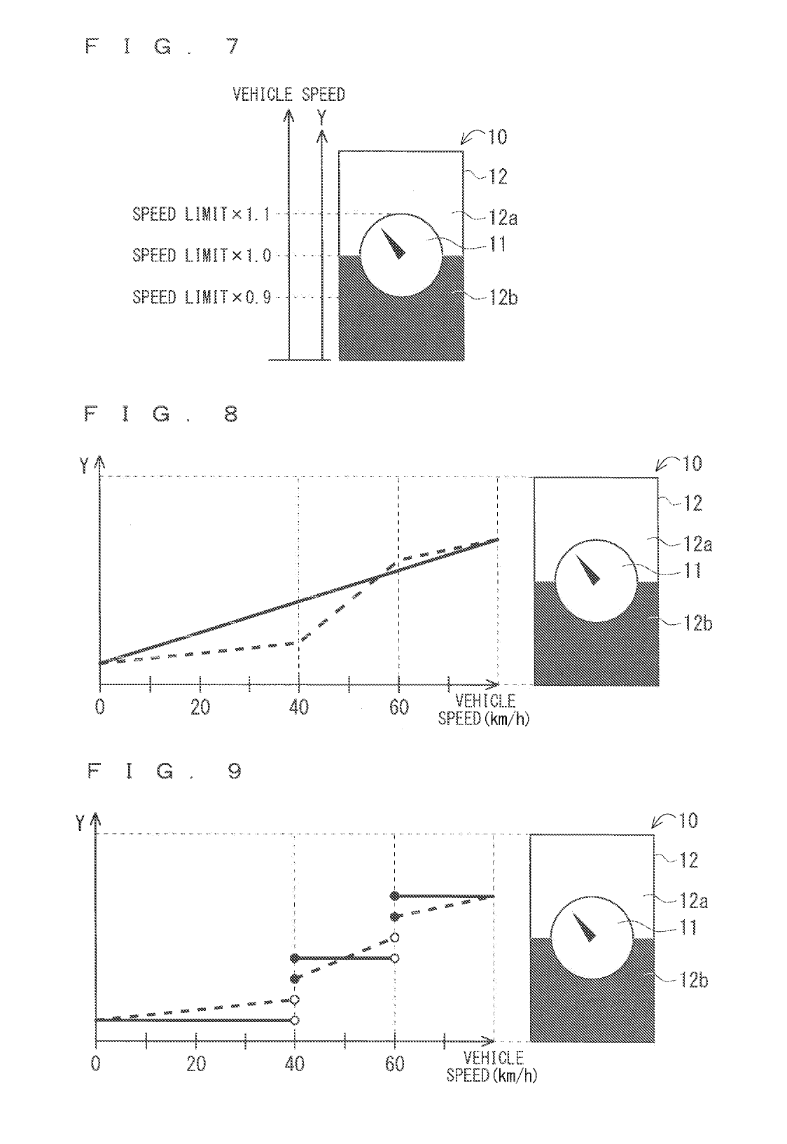

FIG. 7 shows an example of setting the height of the notification region 12b. Note that the setting of the height is not limited to this example. With reference to FIG. 7, the Y axis indicates the height of the notification region 12b, and the axis indicating the vehicle speed is illustrated in the direction equal to that of the Y axis.

FIG. 7 corresponds to the example (see FIG. 3) of the notification region 12b that changes s shape in accordance with the vehicle speed. For the example shown in FIG. 7, in a case where the vehicle speed is equal to the speed limit (the maximum speed in this example), the height of the notification region 12b is set at the center position of the speedometer 11. In a case where the vehicle speed is equal to 110% of the maximum speed, the height of the notification region 12b is set at the upper-edge position of the speedometer 11. In a case where the vehicle speed is equal to 90% of the maximum speed, the height of the notification region 12b is set at the lower-edge position of the speedometer 11.

Alternatively, the height of the notification region 12b for the vehicle speed equal to the speed limit may be set at the upper-edge position of the speedometer 11. Still alternatively, the height of the notification region 12b for the vehicle speed equal to the speed limit may be set at the lower-edge position of the speedometer 11. The height of the notification region 12b for the vehicle speed equal to the speed limit can be set by a user.

The shape of the notification region 12b may be changed continuously or discontinuously.

FIG. 8 shows an example of continuous changes in the shape. With reference to FIG. 8, the horizontal axis indicates the vehicle speed and the vertical axis (the Y axis) indicates the height of the notification region 12b. For the solid characteristic line in the example shown in FIG. 8, the height of the notification region 12b is expressed as a linear function of the vehicle speed being the variable while the rate of change in the height of the notification region 12b is constant.

Alternatively, as indicated by the dashed characteristic line in FIG. 8, a plurality of speed ranges for the vehicle speed may be set in advance, and thus, the rate of change in the height of the notification region 12b may be changed depending on which one of the speed ranges the current vehicle speed belongs to. FIG. 8 illustrates three speed ranges being the speed range of 0 to 40 km/h, the speed range of 40 to 60 km/h, and the speed range of 60 to 80 km/h.

For example, the rate of change in the height of the notification region 12b is increased in the speed range that includes the speed limit and thus conceivably is of keen interest to a user (such as a driver). In this example, the change in the height of the notification region 12b is more responsive to the vehicle speed in the speed range that is of keen interest to the user, thus allowing for the highly-perceivable displaying that conforms to the driver's sense.

With reference to FIG. 8, the dashed characteristic line is continuous regardless of the shift in speed range, and thus, the notification region 12b is displayed as if to continuously change its shape.

The shape of the notification region 12b may be continuously changed with temporal processing. For example, the mean value of the vehicle speed is acquired per predetermined length of time (for example, per second) and the height of the notification region 12b is controlled on the basis of the mean value. If the above-mentioned length of time is shorter, in other words, the displaying of the notification region 12b is updated at shorter time intervals (for example, every 10 milliseconds), the shape of the notification region 12b is changed almost in real time. The updating of the displaying at longer time intervals allows for the displaying more suitable for drivers who do not prefer frequent changes in the shape of the notification region 12b.

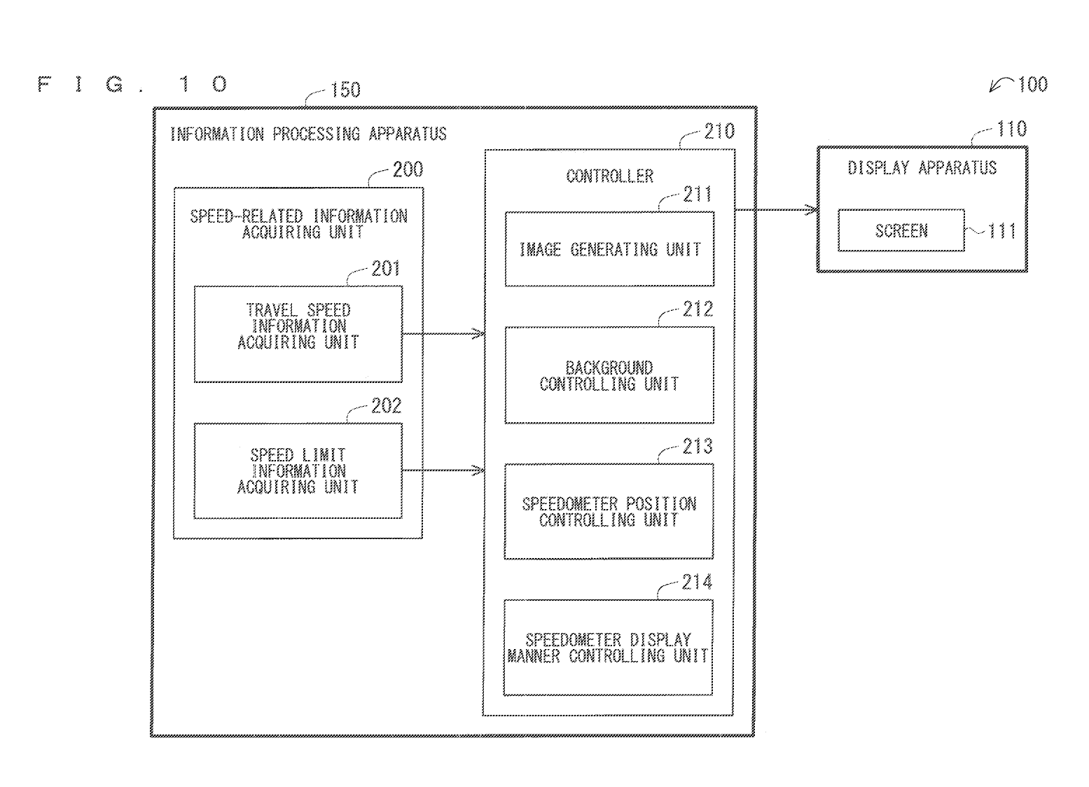

FIG. 9 shows an example of discontinuous changes in the shape. The solid characteristic line in the example shown in FIG. 9 is discontinued when the speed range is shifted. Thus, the notification region 12b is displayed as if to discontinuously change its shape when the speed range is shifted. Thus, it appears that changes in the notification region 12b are discrete. The amounts of change in height at the vehicle speed of 40 km/h and 60 km/h, which are equal to each other in the example shown in FIG. 9, may be different from each other.

With reference to FIG. 9, the solid characteristic line indicates no change in the height of the notification region 12b within each speed range. Alternatively, as indicated by the dashed characteristic line, the shape of the notification region 12b may be changed continuously within part or all of the speed ranges.

The individual characteristic lines in the examples shown in FIGS. 8 and 9 are straight lines. Alternatively, part or all of the characteristic lines may be formed of curved lines.

<Configuration of Apparatus>

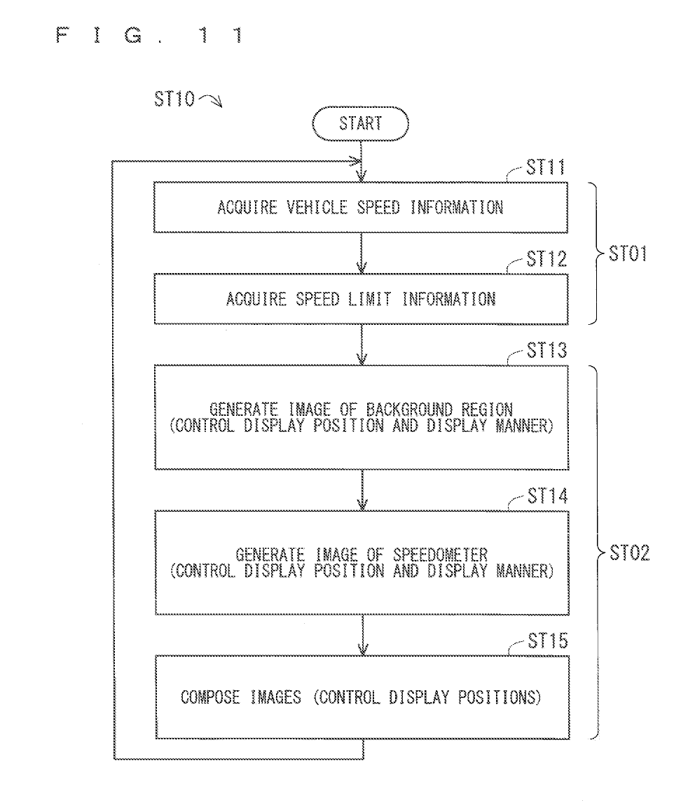

FIG. 10 is a block diagram of an information display apparatus 100 according to the embodiment 1. In the example shown in FIG. 10, the information display apparatus 100 includes a display apparatus 110 and an information processing apparatus 150.

<Display Apparatus>

The display apparatus 110 includes the screen 111 on which the speedometer region 10 is displayed (see FIG. 1). The details to be displayed on the screen 111 are controlled by the information processing apparatus 150. In this example, a liquid crystal display apparatus may be provided as the display apparatus 110. In this case, the display apparatus 110 performs the displaying operation on the basis of the image data supplied by the information processing apparatus 150. Alternatively, other kinds of display apparatuses may be provided as the display apparatuses 110.

The display apparatus 110 may be, for example, a three-dimensional (3D) naked eye stereoscopic display apparatus. In such displaying, the speedometer 11 may be located slightly closer toward the user in the Z axis direction (the Z axis refers to the direction of the normal to the screen 111 (in other words, the display surface) facing the user).

<Information Processing Apparatus>

The information processing apparatus 150 performs various kinds of processing in the information display apparatus 100. The following mainly describes various kinds of processing related to the displaying of the speedometer region 10.

As an example, the following describes the information processing apparatus 150 is provided with a central processing unit (including one microprocessor or a plurality of microprocessors) and a main storage unit (including one storage device such as a ROM, a RAM, and a flash memory or a plurality of storage devices). In this example, the central processing unit executes various kinds of programs stored in the main storage unit, whereby various kinds of processing are performed. The various kinds of processing can be executed in parallel. Each of the various kinds of processing implements the corresponding one of various kinds of functions.

The programs to be executed by the central processing unit may be prestored in the main storage unit. Alternatively, the programs may be read out from an auxiliary storage unit at the time of execution and be stored in the main storage unit. The main storage unit stores not only the programs but also various kinds of data. The main storage unit provides the workspace for the central processing unit in the execution of the programs. The main storage unit provides an image holding unit into which the images to be displayed on the display apparatus 110 are written. The image holding unit is also referred to as a video memory or a graphic memory.

In this example, various functions of the information processing apparatus 150 are implemented by software. Alternatively, all or part of various functions of the information processing apparatus 150 may be implemented by hardware (such as an arithmetic circuit configured to perform particular arithmetic computations).

In the example shown in FIG. 10, the information processing apparatus 150 provides a speed-related information acquiring unit 200 and a controller 210. The speed-related information acquiring unit 200 includes a travel speed information acquiring unit 201 and a speed limit information acquiring unit 202.

<Speed-Related Information Acquiring Unit>

The travel speed information acquiring unit 201 acquires the information on the travel speed of the own vehicle (or equivalently, the vehicle speed). For example, the travel speed information acquiring unit 201 receives, via the in-vehicle local area network (LAN), the data output from the speed sensor installed in the vehicle and analyzes the output data to acquire the vehicle speed (in other words, the vehicle speed value). In a ease where the data output from the speed sensor is the data of the vehicle speed itself, the travel speed information acquiring unit 201 acquires the vehicle speed information by receiving the output data.

Alternatively, the travel speed information acquiring unit 201 may acquire the data output from the position detector such as the global positioning system (GPS). In this case, the travel speed information acquiring unit 201 can acquire the vehicle speed from temporal changes in the position of the own vehicle.

The speed limit information acquiring unit 202 acquires the information on the speed limit for the road on which the own vehicle is located. For example, the speed limit information acquiring unit 202 acquires the data output from the position detector, acquires the position of the own vehicle on the basis of the output data, compares the acquired position of the own vehicle with the map database to specify the road on which the vehicle is located, and acquires the speed limit for the specified road from the map database. The map database may be installed in the vehicle or stored in the server on the communication network (such as the internet) available for the vehicle. In the latter case, the speed limit information acquiring unit 202 accesses the server via the communication apparatus.

The map database is an example of the speed limit information source that stores the position information and the speed limit information in correlation with each other. Thus, the speed limit information for the road on which the own vehicle is located can be acquired from the speed limit information source other than the map database. For example, various kinds of information delivery server on the internet and the VICS (vehicle information communication system) (registered trademark) are also available as the speed limit information source.

The information can be acquired from the speed limit information source in various ways. If the speed limit information source is installed in the vehicle, the in-vehicle LAN is available, for example. If the speed limit information source is located outside the vehicle, the radio communication, the telephone communication, the DSRC (dedicated short range communication), the broadcasting, and the VICS (registered trademark) are available, for example.

Alternatively, the speed limit information acquiring unit 202 may generate a speed limit. For example, the legally permitted speed acquired from the map database may be revised on the basis of the road-related information, whereby the speed limit is generated.

The road-related information refers to various kinds of information related to roads and includes, for example, kinds of roads (such as unpaved roads, roads paved with asphalt, and roads paved with concrete). The information related to the travel environment, such as road surface conditions, the weather, warnings about animals, and warnings about falling rocks, is also an example of the road-related information. The information related to the travel environment includes the information on slowdown sections and closed roads associated with, for example, school-commuting roads, the holding of events, and roadworks.

The speed limit information can be included in the road-related information. However, the speed limit information is hereinafter excluded from the road-related information for the purpose of brevity of description.

Similarly to the speed limit information source mentioned above, the supply source of the road-related information (or equivalently, the road-related information source) is, for example, the map database, various kinds of information delivery server on the internet, and the VICS (registered trademark). The information can be acquired from the road-related information source in various ways as in the case of the speed limit information source mentioned above. For example, the weather, road surface conditions, and kinds of roads can be estimated by various kinds of vehicle-installed sensors. In particular, the weather can be estimated by, for example, a temperature sensor, a humidity sensor, and a raindrop detection sensor. If this is the case, the road-related information source refers to various kinds of sensors.

The ways to use the road-related information in generating the speed limit need to be defined in advance. For example, various kinds of road-related information is converted into numerical values, and then, these numerical values are assigned to the arithmetic operations (put into practice through, for example, calculating formulas and tables) defined in advance, thus providing the coefficient by which the legally permitted speed is to be multiplied. In this example, the legally permitted speed (obtained from, for example, the map database) is multiplied by the obtained coefficient, so that the speed limit is acquired in the speed limit information acquiring unit 202.

Alternatively, the speed limit information acquiring unit 202 may acquire the speed limit information by, for example, extracting the numbers written on the speed limit signs from the video image taken by the vehicle-installed camera through the use of the image recognition technique.

The vehicle speed information acquired by the travel speed information acquiring unit 201 and the speed limit information acquired by the speed limit information acquiring unit 202 are supplied to the controller 210 as the speed-related information and used in changing the shape of the notification region 12b.

In a case where the speed limit information is not used in changing the shape of the notification region 12b, meanwhile, the vehicle speed information alone may be supplied to the controller 210 as the speed-related information. Even if the vehicle information is not used in changing the shape of the notification region 12b, the vehicle speed is necessary for the speedometer 11 to display the vehicle speed, and therefore, the vehicle speed information is supplied to the controller 210.

That is, the speed-related information acquired by the speed-related information acquiring unit 200 and supplied to the controller 210 includes the vehicle speed information alone in some cases and includes both the vehicle information and the speed limit information in other cases.

If the speed limit information is not required, the speed limit information acquiring unit 202 may be omitted. In this case, the speed-related information acquiring unit 200 includes the travel speed information acquiring unit 201 alone.

In a case where the speed-related information acquiring unit 200 includes both the travel speed information acquiring unit 201 and the speed limit information acquiring unit 202, the need of the speed limit information and no need of the speed limit information may be each assigned to different operation modes in advance. Thus, the speed limit information becomes available, as needed, by switching the operation modes. For the operation mode in no need of the speed limit information, the acquisition of the speed limit information itself is halted. Alternatively, the speed limit information is acquired but the supply of the speed limit information to the controller 210 is halted.

<Controller>

In the example shown in FIG. 10, the controller 210 includes an image generating unit 211, a background controlling unit 212, a speedometer position controlling unit 213, and a speedometer display manner controlling unit 214.

The image generating unit 211 generates an image to be displayed on the screen 111. In particular, the image generating unit 211 generates the image data of the speedometer region 10 and the like and writes the image data into the image holding unit. The image data stored in the image holding unit is transferred to the display apparatus 110, and then, is used for the displaying operation in the display apparatus 110. As mentioned above, the image holding unit is provided by, for example, the main storage unit of the controller 210.

The image generating unit 211 is controlled by the background controlling unit 212, the speedometer position controlling unit 213, and the speedometer display manner controlling unit 214 with regard to the generation of the image (in other words, the image data) of the speedometer region 10.

The background controlling unit 212 controls the background region 12 in the speedometer region 10. For example, the background controlling unit 212 supplies the image generating unit 211 with the set value for the display position of the background region 12 on the screen 111. The set value may be unchangeable or may be changeable.

The background controlling unit 212 controls, for example, the display manner of the background region 12 on the screen 111. For example, the background controlling unit 212 supplies the image generating unit 211 with the set values for the shape, the dimension, and the like of the background region 12 and the set values for the shapes, the dimensions, the colors, and the like of the base region 12a and the notification region 12b. These set values may be unchangeable or may be changeable.

The background controlling unit 212, particularly in the embodiment 1, determines the dimensions (the heights in this example) of the base region 12a and the notification region 12b on the screen 111 in accordance with the speed-related information supplied from the speed-related information acquiring unit 200 (see FIGS. 3 to 9) and supplies the image generating unit 211 with the determined set values.

With regard to the example in FIG. 9, the background controlling unit 212 can determine which one of the speed ranges the vehicle speed belongs to. The information on which one of the speed ranges the vehicle speed belongs to may be generated and acquired in the background controlling unit 212. Alternatively, the background controlling unit 212 may acquire, from the speed-related information acquiring unit 200, the information on the determination results as the speed-related information.

The speedometer position controlling unit 213 controls the positional relationship between the speedometer 11 and the background region 12 on the screen 111, in other words, the display position of the speedometer 11 in the background region 12. For example, the speedometer position controlling unit 213 supplies the image generating unit 211 with the set value for the display position of the speedometer 11. The set value may be unchangeable or may be changeable. In the embodiment 1, the display position of the speedometer 11 is fixed to the midsection of the background region 12 as mentioned above, and therefore, the center position is presented to the image generating unit 211.

The speedometer display manner controlling unit 214 controls the display manner of the speedometer 11 on the screen 111. For example, the speedometer display manner controlling unit 214 supplies the image generating unit 211 with the set values for, for example, the shape, the dimension, and the color of the speedometer 11. These values may be unchangeable or may be changeable.

The control over the display manner of the speedometer 11 does not include the control over the inherent displaying of the vehicle speed. With reference to, for example, FIG. 2 in which the speedometer 11 being the pointer display speedometer is specifically illustrated, assume that the angle of the pointer is controlled in accordance with the vehicle speed by, for example, a speed display controlling unit (not shown), not by the speedometer display manner controlling unit 214.

<Operation>

FIG. 11 is the flowchart describing the operation of the information processing apparatus 150. With reference to an operational flow ST10 illustrated in FIG. 11, the travel speed information acquiring unit 201 acquires the vehicle speed information in step ST11 and the speed limit infatuation acquiring unit 202 acquires the speed information in step ST12.

Steps ST11 ST12 constitute step ST01 of acquiring the speed-related information.

Next, in step ST13, the image generating unit 211 generates the image of the background region 12. At this time, the background controlling unit 212 controls the display position and the display manner of the background region 12. The dimension (the height in this example) of each of the base region 12a and the notification region 12b included in the background region 12 is controlled, particularly in the embodiment 1, in accordance with the speed-related information.

Next, in step ST14, the image generating unit 211 generates the image of the speedometer 11. At this time, the speedometer position controlling unit 213 and the speedometer display manner controlling unit 214 control the display position and the display manner of the speedometer 11, respectively.

Then, in step ST15, the image generating unit 211 composes the image of the speedometer 11 and the image of the background region 12 by, for example, layer superposition. The data on the composed image is transferred to the image display 110, and then, the composed image is displayed on the screen 111. In a case where only the image objects of the background region 12 and the speedometer 11 are generated in steps ST13 and ST14 and these image objects are laid out in step ST15, the background controlling unit 212 and the speedometer position controlling unit 213 control the display positions of the background region 12 and the speedometer 11 in step ST15.

Steps ST13 to ST15 constitute step ST02 of controlling the display manner of the speedometer region 10.

Steps ST11 to ST15 are repeated, so that the display manner of the speedometer region 10 changes in accordance with the speed-related information.

Step ST12 may be performed ahead of step ST11. Step ST14 may be performed ahead of step ST13.

In a case where the speed limit is expected to remain unchanged based on the knowledge obtained through the cooperation with the navigation function, the need for performing step ST12 on a regular basis is conceivably reduced. Thus, step ST12 could be omitted until the vehicle reaches the point in which there is a change in speed limit.

Once the display position of the background region 12 is set, the control over the display position of the background region 12 in step ST13 or step ST15 could be omitted until the display position of the background region 12 is changed by, for example, the user. For example, it is required that the set value for the display position supplied from the background control unit 212 be held by the image generating unit 211. The same holds true for the control over the display position and the display manner of the speedometer 11.

<Effects>

In the embodiment 1, the caution level about the vehicle speed can be intuitively perceived through the height (in other words, the size) of the notification region 12b. That is, the caution level is intuitively perceived to be higher when the notification region 12b is larger.

The changes in the caution level about the vehicle speed can be intuitively perceived through the changes in the height (in other words, the extension and contraction) of the notification region 12b. The shape and the dimension of the entirety of the background region 12 do not change, and accordingly, the expansion of the notification region 12b results in the downsizing of the base region 12a. The comparative observation of the notification region 12b and the base region 12a is performed consciously or subconsciously, and accordingly, the size and the changes in the size of the notification region 12b can be easily perceived.

The speedometer region 10 includes the speedometer 11 and the background region 12, and thus, the presence of the speedometer 11 serves as the guide for obtaining the height and the changes in the height of the notification region 12b. Thus, according to the speedometer region 10, the height and the changes in the height of the notification region 12b can be easily perceived.

The combinations of the notification region 12b and the speedometer 11 can expand variety of their display manners. For example, the caution level is intuitively perceived to be lower when the notification region 12b is located farther from the speedometer 11. Conversely, the caution level is intuitively perceived to be higher when the notification region 12b moves closer to the speedometer 11. The much higher caution level is intuitively perceived through the degree of the overlap between the notification region 12b and the speedometer 11 and the degree of the notification region 12b beyond the entirety of the speedometer 11.

As mentioned above, the speedometer region 10 can provide various display manners. A lot of information can be provided in an integrated manner through the various display manners. Thus, the user can obtain, along with the vehicle speed, other pieces of information (caution about the vehicle speed in this example) by looking at the speedometer region 10. This results in, for example, improved convenience.

### Embodiment 2

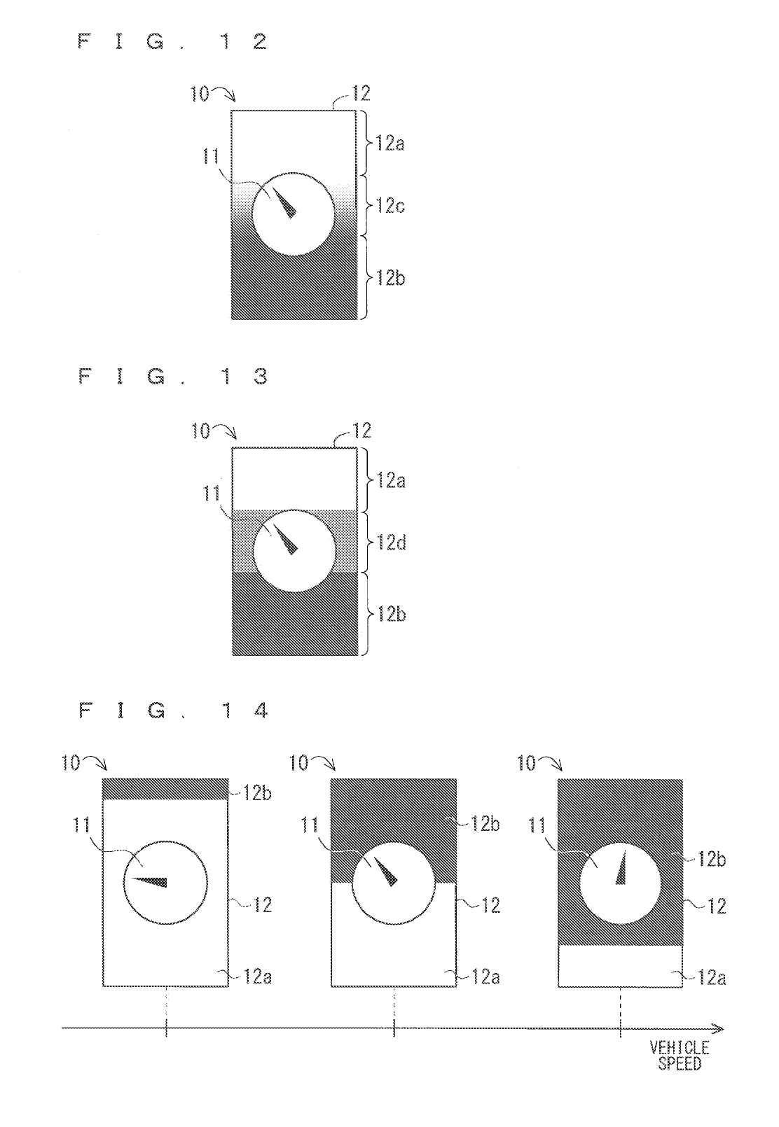

In the embodiment 1, the description has been given on the example of the background region 12 including two regions being the base region 12a and the notification region 12b for the purpose of the brevity of the drawings. Alternatively, the background region 12 may include another region. For example, as illustrated in FIGS. 12 and 13, intermediate regions 12c and 12d may be provided between the base region 12a and the notification region 12b.

The intermediate region 12c in FIG. 12 has the design that provides continuity across the base region 12a side and the notification region 12b side through continuous changes. In particular, the intermediate region 12c provides gradations of color changing from red to black. In the example shown in FIG. 12, the gradations include a large number of steps (in other words, the gradations are dense), thus providing smooth changes. If the number of steps in gradations is reduced, meanwhile, the step boundaries are visually recognized in some cases. The gradations provide continuity across the base region 12a and the notification region 12b through continuous changes regardless of the density of the gradations.

The intermediate region 12d in FIG. 13 has the design that is discontinuous on both the base region 12a side and the notification region 12b side. For example, the intermediate region 12d is the region in yellow (assuming the intermediate region 12d does not have variations in all of the three elements of color). Yellow is generally used as the color for calling attention.

The continuous intermediate region 12c may be combined with the discontinuous intermediate region 12d. For example, the discontinuous intermediate region 12d is provided adjacent to the notification region 12b and the continuous intermediate region 12c is provided between the discontinuous intermediate region 12d and the base region 12a. In this example, the continuous intermediate region 12c is set to have gradations of color changing continuously from yellow to black. The discontinuous intermediate region 12d has the design that is discontinuous on the notification region 12b side and continuous on the continuous intermediate region 12c side (in other words, the base region 12a side). The intermediate region 12c may change positions with the intermediate region 12d. A plurality of intermediate regions 12c may be provided. Similarly, a plurality of intermediate regions 12d may be provided.

The heights of the intermediate regions 12c and 12d may be set at fixed values that are unchangeable or may be set at variable values changing in accordance with, for example, speed-related information.

An embodiment 2 produces the effect similar to that of the embodiment 1 The embodiment 2 may be combined with other embodiments.

### Embodiment 3

In an embodiment 3, the change in the shape of the notification region 12b is further described.

With reference to, for example, FIG. 3 mentioned above, the extension-and-contraction direction of the notification region 12b is the height direction of the background region 12 and the height of the notification region 12b increases with increasing vehicle speed. In this case, the extension-and-contraction direction of the notification region 12b is constant. This extension-and-contraction direction is discussed for the individual states where (i) the notification region 12b does not overlap the speedometer 11 on the screen 111, (ii) the notification region 12b overlaps part of the speedometer 11 on the screen 111 (including the state of point contact), and (iii) the notification region 12b overlaps the entirety of the speedometer 11 on the screen 111.

The extension-and-contraction direction of the notification region 12b in the above-mentioned state (i) can be regarded as the direction in which the gap between the notification region 12b and the speedometer 11 changes. The extension-and-contraction direction in the state (i) is hereinafter referred to an extension-and-contraction direction (I) or a direction (I).

The extension-and-contraction direction of the notification region 12b in the above-mentioned state (ii) can be regarded as the direction in which the amount of the overlap between the notification region 12b and the speedometer 11 changes. The extension-and-contraction direction in the state (ii) is hereinafter referred to as an extension-and-contraction direction (II) or a direction (H).

The extension-and-contraction direction of the notification region 12b in the above-mentioned state (iii) can be regarded as the direction in which the notification region 12b can change its shape while the notification region 12b overlaps the entirety of the speedometer 11. The extension-and-contraction direction in the state (iii) is hereinafter referred to as an extension-and-contraction direction (III) or a direction (III).

In other words, the extension-and-contraction direction of the notification region 12b in the example shown in FIG. 3 includes all of the extension-and-contraction directions (1), (II), and (III). If the range in which the notification region 12b extends and contracts is restricted, the extension-and-contraction direction of the notification region 12b may not include the extension-and-contraction direction (III) or may not include the extension-and-contraction directions (II) and (III). The restrictions imposed on the range in which the notification region 12b extends and contracts includes the restriction for prohibiting the notification region 12b from overlapping an alarm light if the alarm light is displayed in the base region 12a.

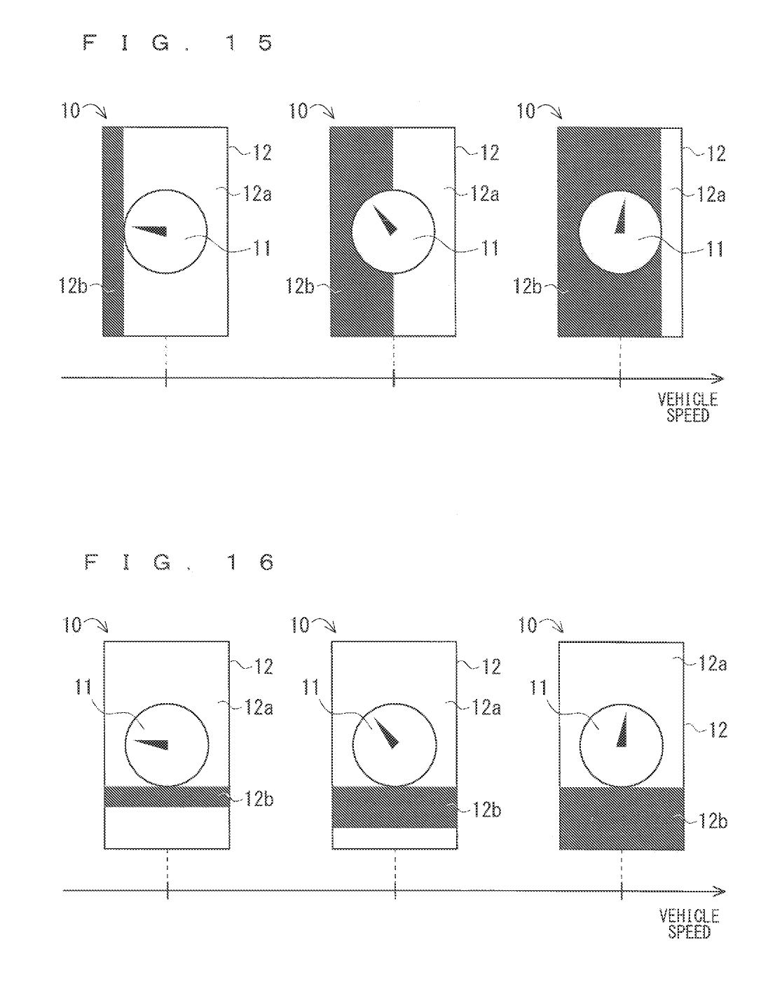

FIGS. 14 to 19 illustrate other examples of change in the shape of the notification region 12b.

In the example shown in FIG. 14, the notification region 12b is located on the upper side of the background region 12 and the base region 12a is located on the lower side of the background region 12. The notification region 12b extends to the lower side as the vehicle speed increases. In this example, the extension-and-contraction direction of the notification region 12b is the height direction of the background region 12 and may include all of the directions (I), (II), and (III).

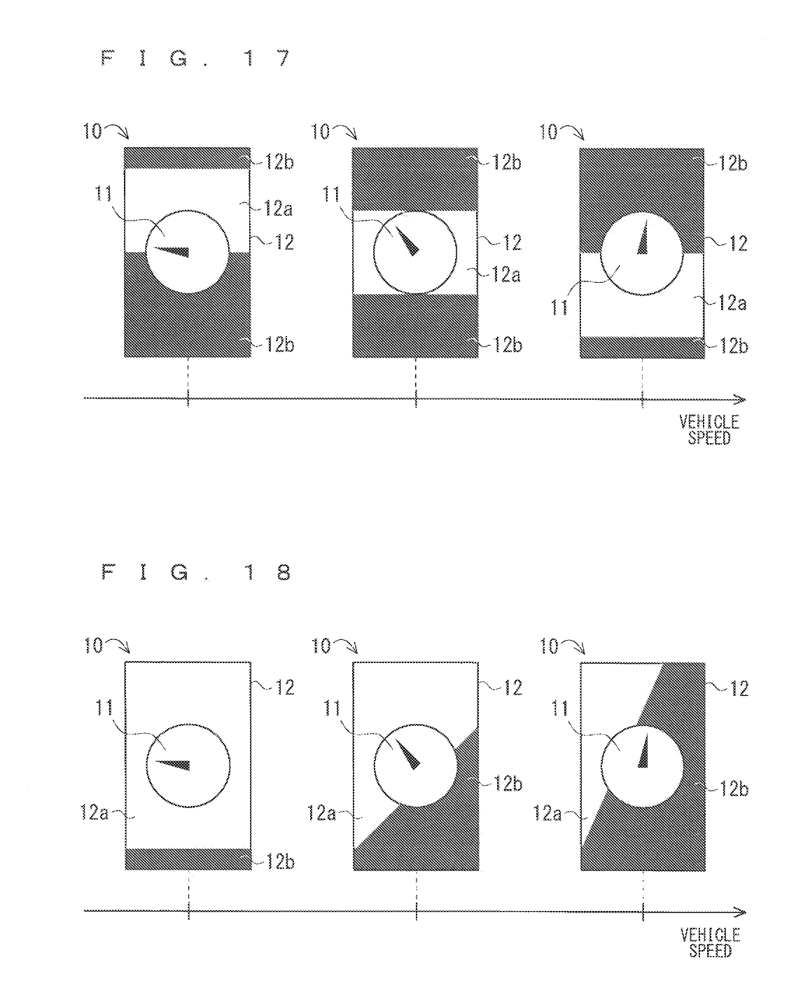

In the example shown in FIG. 15, the notification region 12b is located on the left side of the background region 12 and the base region 12a is located on the right side of the background region 12. The notification region 12b extends to the right side as the vehicle speed increases. In this example, the extension-and-contraction direction of the notification region 12b is the width direction (in other words, the horizontal direction) of the background region 12 and may include all of the directions (I), (II), and (III). In contrast to the example shown in FIG. 15, the notification region 12b may be located on the right side of the background region 12. In this case, the notification region 12b extends to the left side as the vehicle speed increases. In this example as well, the extension-and-contraction direction of the notification region 12b may include all of the directions (I), (II), and (III).

In the example shown in FIG. 16, the fixed edge of the notification region 12b is located between the speedometer 11 and the outline of the background region 12. The notification region 12b extends and contracts only within the region between the speedometer 11 and the outline of the background region 12b. In the example shown in FIG. 16, the extension-and-contraction direction of the notification region 12b is the height direction of the background region 12 but does not include any one of the directions (I), (II), and (III). As shown in this example, even if the notification region 12b extends and contracts in the direction other than the extension-and-contraction directions (I), (II), and (III), the effects of the embodiment 1 can be produced.

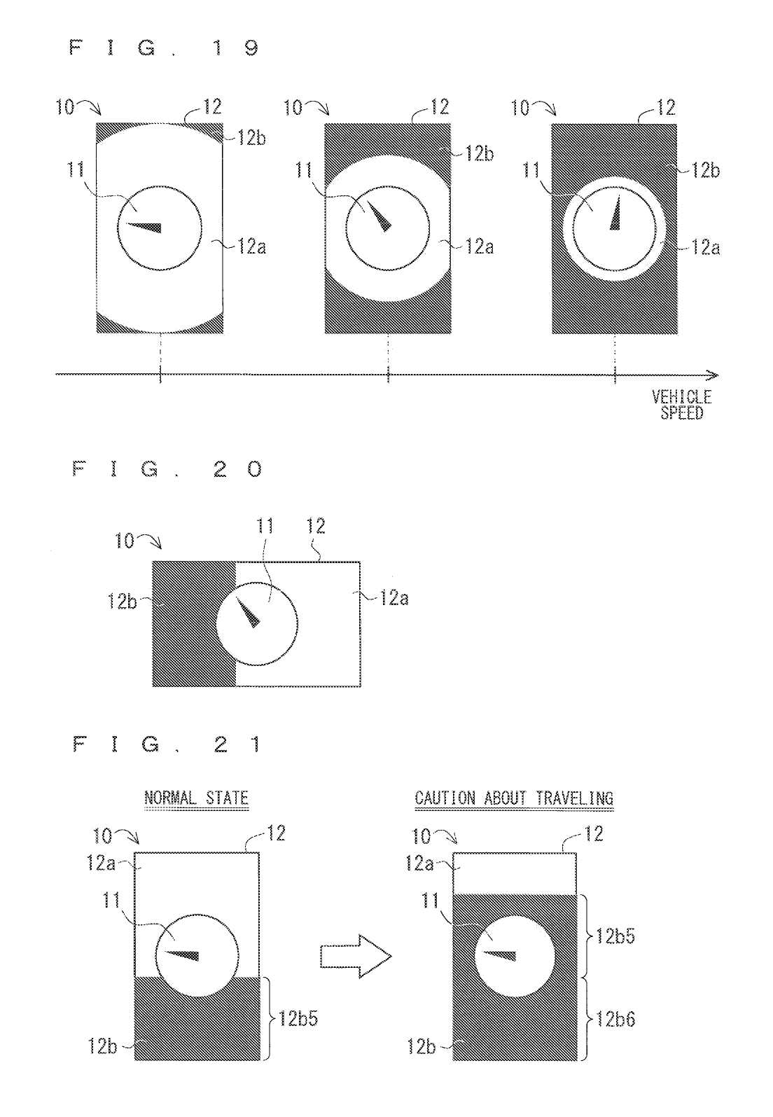

In the example shown in FIG. 17, the notification regions 12b are provided on the upper side and the lower side of the background region 12. As in the example shown in FIG. 14, the notification region 12b on the upper side extends to the lower side as the vehicle speed increases. The extension-and-contraction direction of the notification region 12b on the upper side can accordingly include all of the directions (I), (II), and (III). Meanwhile, the notification region 12b on the lower side contracts to the lower side with increasing vehicle speed and extends to the upper side with decreasing vehicle speed. The extension-and-contraction direction of the notification region 12b on the lower side can also include all of the directions (I), (II), and (III).

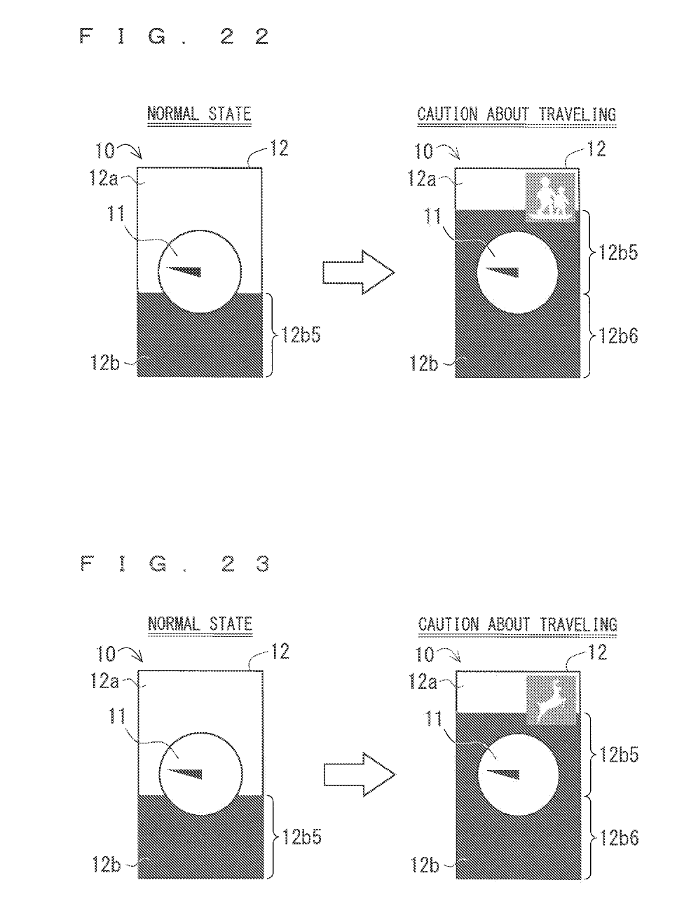

In the example shown in FIG. 18, the notification region 12b extends from the lower right side to the upper right side of the background region 12 with increasing vehicle speed and contracts from the upper left side to the lower right side of the background region 12 with decreasing vehicle speed. Thus, the extension-and-contraction direction of the notification region 12b is the direction in which the lower right side and the upper left side of the background region 12 are linked. This extension-and-contraction direction may be liner or curved (for example, arched). In the example shown in FIG. 18, the extension-and-contraction direction of the notification region 12b can be considered as the height direction of the background region 12. In the example shown in FIG. 18 as well, the extension-and-contraction direction of the notification region 12b may include all of the directions (I), (II), and (III).

In the example shown in FIG. 19, the notification region 12b surrounds the speedometer 11. The background region 12 omnidirectionally moves closer to the speedometer 11 side as the vehicle speed increases. Conversely, the background region 12 omnidirectionally moves away from the speedometer 11 side as the vehicle speed decreases. In this case, the extension-and-contraction direction of the notification region 12b is radial with the position of the speedometer 11 as the center. In the example shown in FIG. 19, the extension-and-contraction direction of the notification region 12 can include the directions (I) and (II) but does not include the direction (III).

The above description is also applicable to the case in which the shape of the notification region 12b changes in accordance with the speed limit and the case in which the shape of the notification region 12b changes in accordance with both the vehicle speed and the speed limit. The embodiment 3 produces the effect similar to that of the embodiment 1. The embodiment 3 may be combined with other embodiments.

### Embodiment 4

In the example shown in FIG. 1 mentioned above, the speedometer region 10 is displayed on the right side of the screen 111. Meanwhile, the speedometer region 10 may be provided in the midsection of the screen 111 or on the left side of the screen 111. The screen is divided into regions, which are not limited to the examples in FIG. 1. Optionally, any display position of the speedometer region 10 may be set.

The speedometer region 10 may be superimposed on another image. For example, the speedometer region 10 may be displayed on part of the region in which the map is displayed.

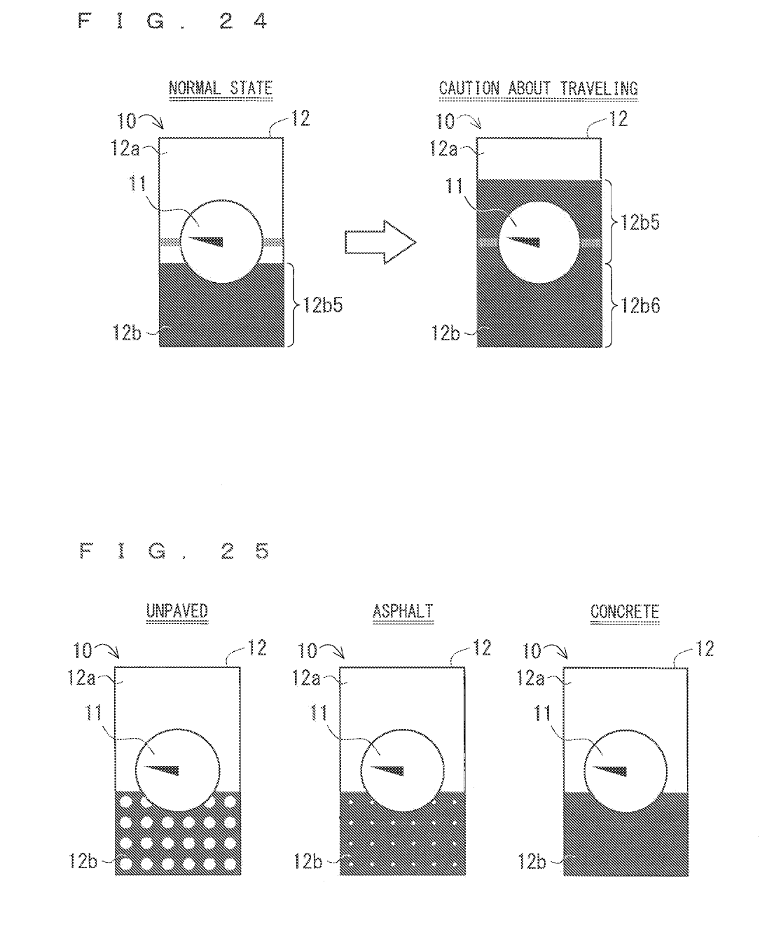

The speedometer region 10 may be located in the upper part or the lower part of the screen 111. In this case, as shown in FIG. 20, the landscape orientation of the background region 12 allows for the efficient layout of the regions on the screen 111. For the landscape orientation, the longitudinal direction of the background region 12 corresponds to the horizontal direction (in other words, the width direction) of the screen 111. In the example shown in FIG. 20, the notification region 12b extends and contracts in the horizontal direction. However, the extension-and-contraction direction of the notification region 12b is not limited to this example.

An embodiment 4 produces the effect similar to that of the embodiment 1. The embodiment 4 may be combined with other embodiments.

### Embodiment 5

In an embodiment 5, the description is given on the example of controlling the display manner of the background region 12 in accordance with the road-related information being the information on the road on which the vehicle is located. As described in the embodiment 1, the road-related information refers to various kinds of information related to roads and includes, for example, kinds of roads (such as unpaved roads, roads paved with asphalt, and roads paved with concrete). The information related to the travel environment, such as road surface conditions, the weather, warnings about animals, and warnings about falling rocks, is also an example of the road-related information. The information related to the travel environment includes the information on slowdown sections and closed roads associated with, for example, school-commuting roads, the holding of events, and roadworks.

The speed limit information can be included in the road-related information. However, the speed limit information is hereinafter excluded from the road-related information for the purpose of brevity of description.

The road-related information source is, for example, the map database, various kinds of information delivery server on the internet, and the VICS (registered trademark). The information can be acquired from the road-related information source in various ways as in the case of the speed limit information source mentioned above. For example, the weather, road surface conditions, and kinds of roads can be estimated by various kinds of vehicle-installed sensors. In particular, the weather can be estimated by a temperature sensor, a humidity sensor, and a raindrop detection sensor. If this is the case, the road-related information source refers to various kinds of sensors.

In particular, as illustrated in FIG. 21, in a case where the detail of the road-related information suggests the need for caution about traveling, the notification region 12b appears larger than the notification region 12b in the normal state (the state with no reflection of the road-related information in this example).

In the example shown in FIG. 21, the notification region 12b includes a speed-related information associated section 12b5 and a road-related information associated section 12b6. The shape of the speed-related information associated section 12b5 changes in accordance with the speed-related information as in, for example, the embodiment 1. The shape of the road-related information associated section 12b6 changes in accordance with the road-related information. For example, the height of the road-related information associated section 12b6 is set at zero in the normal state. In a case where the detail of the road-related information suggesting the need for caution about traveling is acquired, the height of the road-related information associated section 12b6 is set at a preset height. The preset height may be constant regardless of the detail of the road-related information or may be set for each detail of the road-related information. FIG. 21 schematically illustrates the speed-related information associated section 12b5 and the road-related information associated section 12b6, but does not limit, for example, the positions of the two sections 12b5 and 12b6.

The detail suggesting the need for caution about traveling may be, for example, the fact that road surface is slippery or the fact that an event is held. Alternatively, the detail suggesting the need for caution about traveling may be, for example, the fact that the road is a school-commuting road (inclusive of a time-designated school commuting road) or the fact that children are walking or going to walk along the road on a school outing or an extracurricular activity. Still alternatively, the detail suggesting the need for caution about traveling may be, for example, the warning about animals (not only the warning in effect for all the time but also the fact of the sudden appearance of animals).

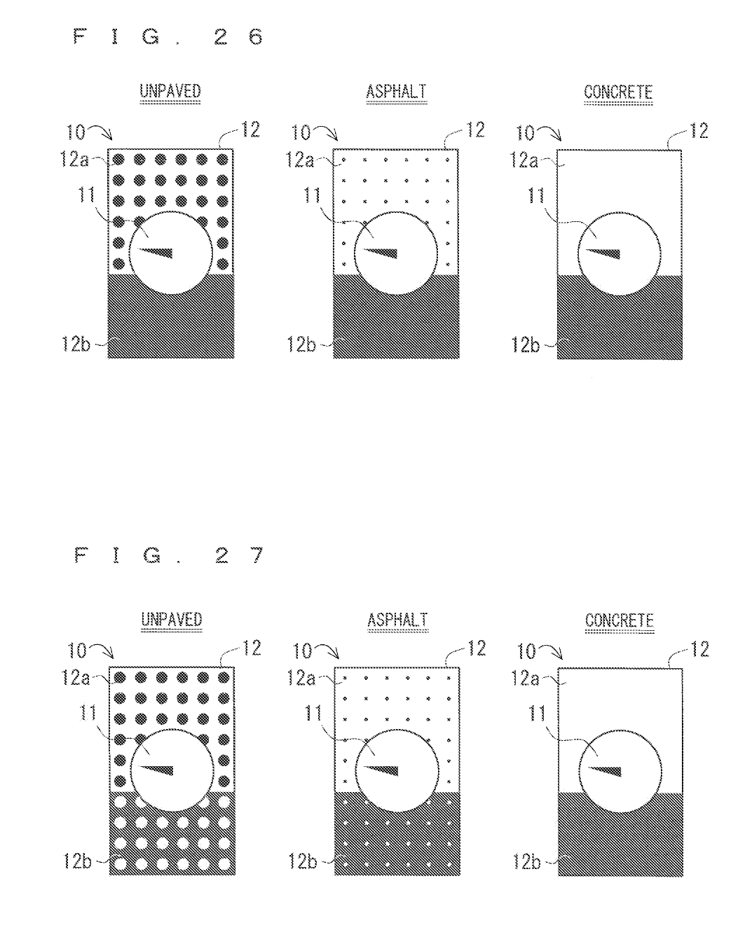

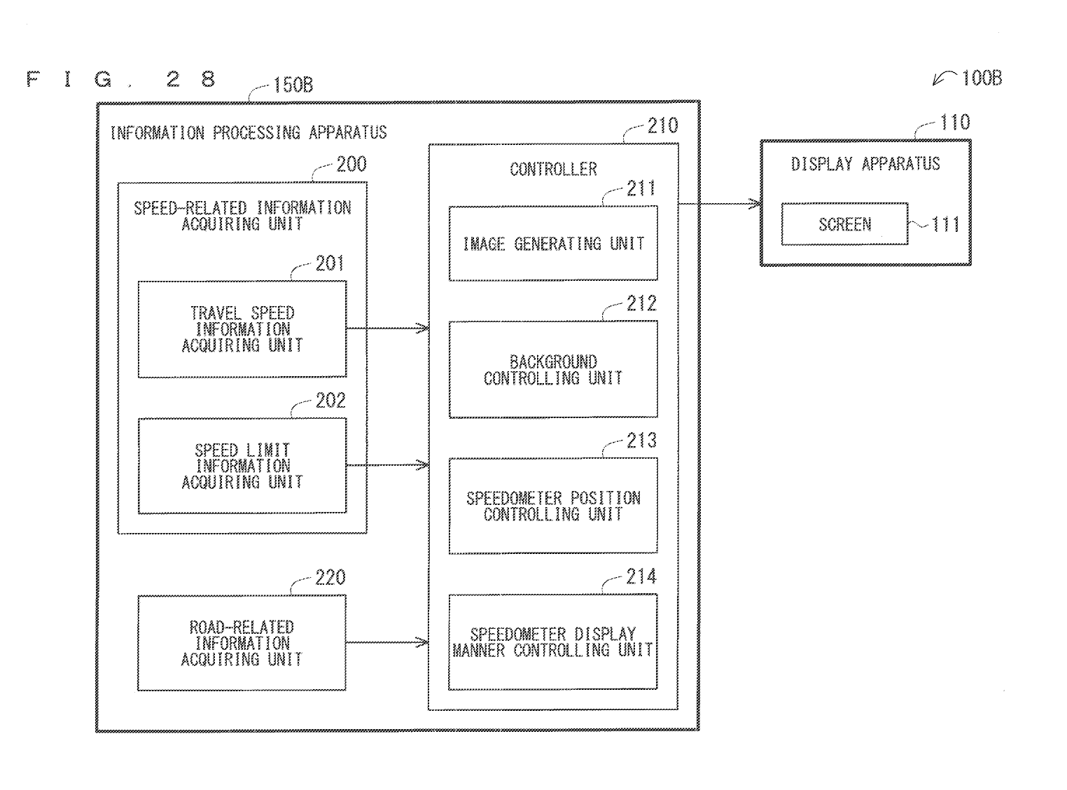

In a case where the road-related information associated section 12b6 is provided, the background controlling unit 212 may instruct the image generating unit 211 to display the objects indicating the above-mentioned facts. If the detail that suggests the need for caution about traveling calls attention to children on, for example, a school-commuting road, the object indicating such fact may be displayed as illustrated in FIG. 22. The same holds true for the caution about animals, which is illustrated in FIG. 23. The displaying of such objects can provide a notification that that the road-related information associated section 12b6 is provided. The different kinds of such objects can provide notifications of different reasons why the road-related information associated section 12b6.

Where appropriate, the object indicating the compliance with speed limit may be displayed. For example, as shown in FIG. 24, a line orthogonal to the extension-and-contraction direction of the notification region 12b is displayed. For example, the color of this line is preferably different from the color for calling attention and preferably provides safety. The color of this line is preferably, for example, blue. The displaying of such object can provide a notification of the compliance with the speed limit. As illustrated in FIG. 24, the above-mentioned line may be displayed not only in the state in which the road-related information associated section 12b6 is provided but also in the normal state.

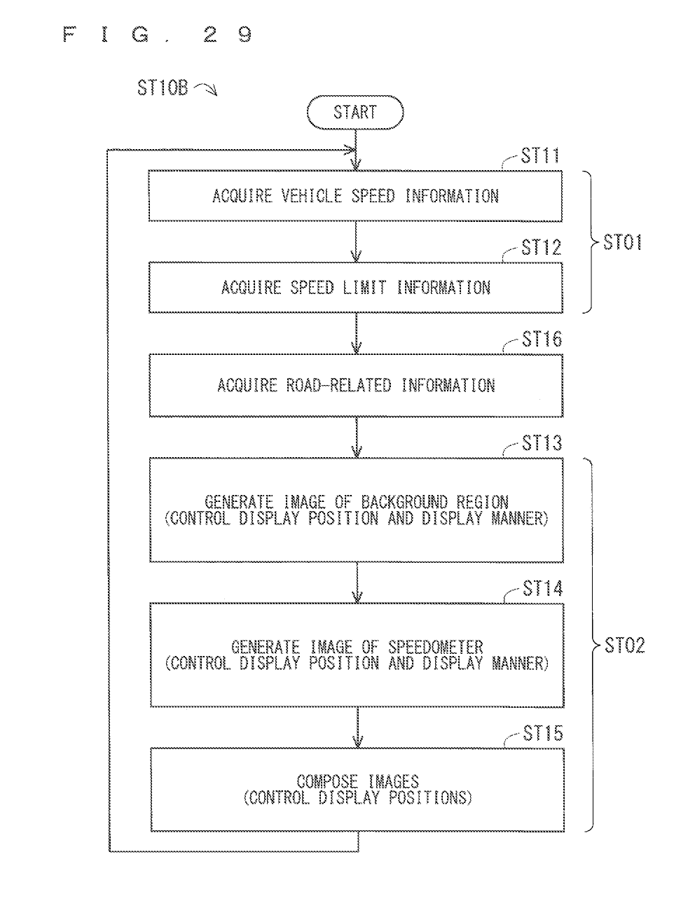

In a case where the road-related information refers to the kinds of roads, the display manner of the background region 12 may be controlled depending on the kinds of roads. For example, as shown in FIGS. 25 to 27, the background region 12 has different patterns for different roads including an unpaved road, a road paved with asphalt, and a road paved with concrete.

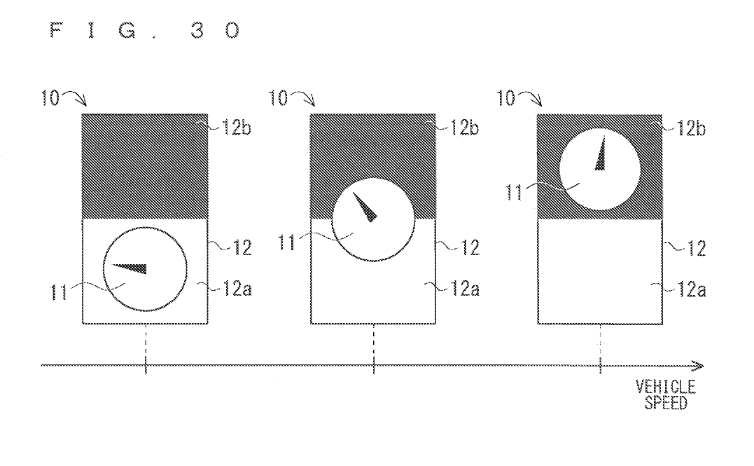

In particular, in the example shown in FIG. 25, the pattern of the notification region 12b is changed. In the example shown in FIG. 26, the pattern of the base region 12a is changed. In the example shown in FIG. 27, the patterns of the base region 12a and the notification region 12b are changed, or equivalently, the pattern of the entire background region 12 is changed. In these examples, the pattern with larger polka dots is applied to the unpaved road, the pattern with smaller polka dots is applied to the road paved with asphalt, and the plain pattern is applied to the road paved with concrete. The kinds of patterns are not limited to the above.

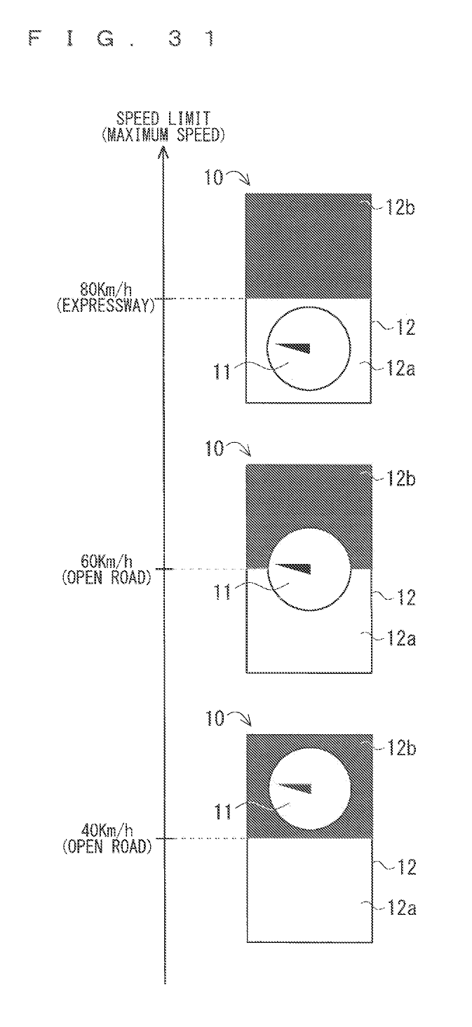

FIG. 28 is the block diagram of an information display apparatus 100B according to the embodiment 5. In the example shown in FIG. 28, the information display apparatus 100B includes the display apparatus 110 and an information processing apparatus 150B. The display apparatus 110 is similar to the one in the embodiment 1 and the description thereof is omitted. In the information processing apparatus 150B according to the embodiment 5, a road-related information acquiring unit 220 is added to the information processing apparatus 150 (see FIG. 10) according to the embodiment 1.

The road-related information acquiring unit 220 acquires, from the road-related information source, the road-related information related to the road on which the own vehicle is located. The examples of the road-related information source are as described above. The road-related information is supplied to the controller 210. The controller 210 (in particular, the background controlling unit 212) controls the display manner of the background region 12 in accordance with the road-related information.

In a case where the speed limit information acquiring unit 202 uses the road-related information, the speed limit information acquiring unit 202 may be supplied with the road-related information acquired by the road-related information acquiring unit 220. This example can eliminate the need for the redundant acquisition of the road-related information.

FIG. 29 is a flowchart describing the operation of the information processing apparatus 150B. An operational flow ST10B illustrated in FIG. 29 is the flow in which step ST16 of acquiring the road-related information is added to the operational flow ST10 (see FIG. 11) according to the embodiment 1.

In the example shown in FIG. 29, step ST16 is performed between step ST12 of acquiring the speed limit information and step ST13 of generating the image of the background region. It is only required that step ST16 be performed before step ST13 of generating the image of the background region. In a case where the road-related information is used in the acquisition of the speed limit information, step ST16 of acquiring the road-related information is preferably performed ahead of step ST12 of acquiring the speed limit information. This is because such sequence eliminates the need for acquiring the road-related information once again in step ST12 of acquiring the speed limit information.

In the embodiment 5, the display manner of the background region 12 is controlled in accordance with the road-related information, further expanding the variety of the display manner of the speedometer region 10. This provides a wider variety of information to the user, thus resulting in, for example, improved convenience.

The embodiment 5 may be combined with other embodiments.

### Embodiment 6

In an embodiment 6, the display position (the height position in this example) of the speedometer 11 in the background region 12 is controlled in accordance with the speed-related information, whereby the display manner of the speedometer region 10 is controlled. Assume that the display manner of the background region 12 is unchanged in the embodiment 6 for easy understanding of the description.

The configuration and the operation of the information display apparatus and the information processing apparatus according to the embodiment 6 are basically similar to those of the information display apparatus 100 and the information processing apparatus 150 (see FIGS. 10 and 11) according to the embodiment 1. The difference lies in that the control over the display position of the speedometer 11 performed by the speedometer position controlling unit 213 is based on the speed-related information.

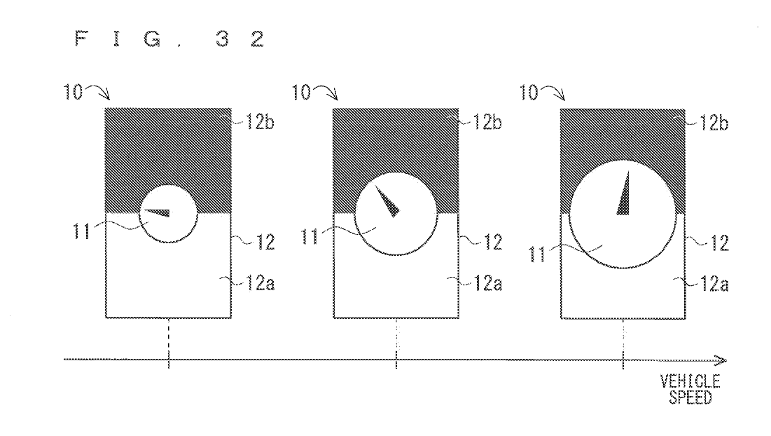

FIG. 30 shows an example of controlling the display position of the speedometer 11 in accordance with the vehicle speed. In the example shown in FIG. 30, as the vehicle speed increases, the display position of the speedometer 11 is brought closer toward the distant edge (equivalent to the upper edge of the background region 12 in this example) of the notification region 12b located far from the base region 12a. At this time, the display position of the speedometer 11 moves away from the distant edge (equivalent to the lower edge of the background region 12 in this example) of the base region 12a located far from the notification region 12b.

The correlation of the display position of the speedometer 11 (such as the height position of the center of the speedometer 11) with the vehicle speed can be obtained by applying, for example, the correlation of the height position of the notification region 12b with the vehicle speed described in the embodiment 1 (see FIGS. 7 to 9).

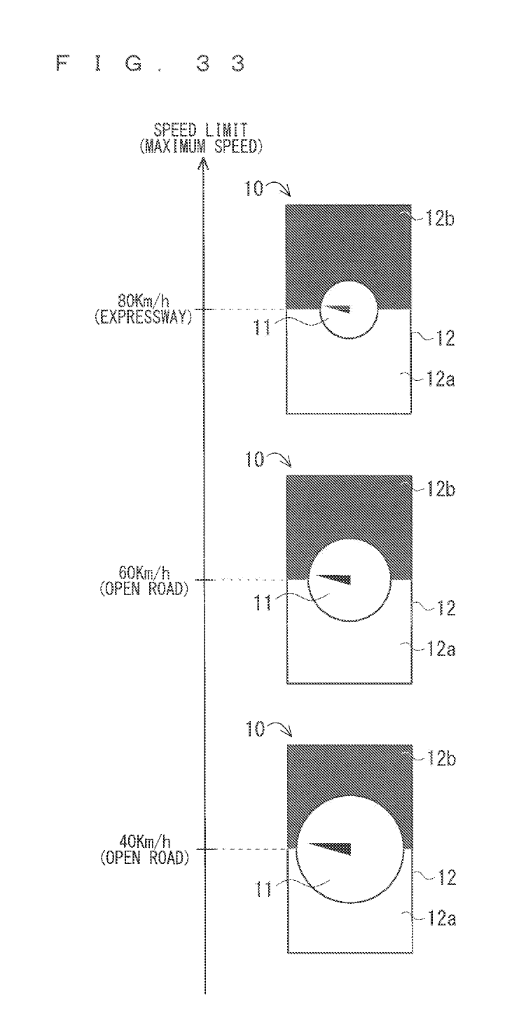

FIG. 31 shows an example of controlling the display position of the speedometer 11 in accordance with the speed limit (the maximum speed in this example) for the road on which the vehicle is located. In the example shown in FIG. 31, the display position of the speedometer 11 is moved away from the above-mentioned distant edge (equivalent to the upper edge of the background region 12 in this example) of the notification region 12b as the speed limit increases while the vehicle speed remains constant. At this time, the display position of the speedometer 11 moves closer toward the above-mentioned distant edge of the base region 12a.

The display position of the speedometer 11 can be controlled in accordance with both the vehicle speed and the speed limit. The display position of the speedometer 11 may be changed continuously or may be changed discontinuously.

In the examples shown in FIGS. 30 and 31, the notification region 12b is located in the upper part of the background region 12. Note that the position of the notification region 12b is not limited to these examples. The direction in which the display position of the speedometer 11 moves is not limited to the height direction (or equivalently, the vertical direction) illustrated in FIGS. 30 and 31. For example, the speedometer 11 may be moved in the width direction (or equivalently, the horizontal direction) of the background region 12, and this example is preferable for the case where the background region 12 is oriented in the landscape (see FIG. 20).

In the embodiment 6, the caution level about the vehicle speed can be intuitively perceived through the display position of the speedometer 11. That is, the caution level is intuitively perceived to be higher when the degree of overlap between the speedometer 11 and the notification region 12b and the degree of entry by the speedometer 11 into the notification region 12b are greater. In other words, it can be intuitively perceived that the vehicle speed is still below the speed limit when the degree of overlap between the speedometer 11 and the notification region 12b is smaller or when the speedometer 11 is located farther from the notification region 12b.

The changes in the caution level about the vehicle speed can be intuitively perceived through the changes in the display position of the speedometer 11, the changes in the above-mentioned degree of overlap, and the changes in the above-mentioned degree of entry.

The background region 12 includes the base region 12a and the notification region 12b. The presence of these regions 12a and 12b and the presence of their boundary serve as the guide for obtaining the position and the changes in the position of the speedometer 11. Thus, the position and the changes in the position of the speedometer 11 can be easily perceived through the speedometer region 10.

As mentioned above, the speedometer region 10 can provide various display manners. A lot of information can be provided in an integrated manner through the various display manners. Thus, the user can obtain, along with the vehicle speed, other pieces of information (caution about the vehicle speed in this example) by looking at the speedometer region 10. This results in, for example, improved convenience.

Although the two-dimensional (2D) display example is shown in FIG. 30, a three-dimensional (3D) display manner may be used. For example, the Z value for the three-dimensional display of the speedometer 11 (the value on the Z axis that refers to the direction of the normal to the display surface facing the user) may be increased as the vehicle speed increases.

In a case where the 3D naked eye stereoscopic display is used, the display manner may be employed in which the speedometer 11 floats up from the background region 12. In this display manner, the speedometer 11 may float up further as it moves closer to the notification region 12b. Conversely, the Z value may decrease to match with the height of the notification region 12b.

Optionally, a choice of display manners may be offered so as to suit the user's preferences.

The 3D display manner and the 3D naked eye stereoscopic display may be applied to the notification region 12b in the embodiment 1.

The embodiment 6 may be combined with other embodiments.

### Embodiment 7

In an embodiment 7, the display manner of the speedometer 11 is controlled in accordance with the speed-related information, whereby the display manner of the speedometer region 10 is controlled. Assume that the display manner of the background region 12 is unchanged in the embodiment 7 for easy understanding of the description.

The configuration and the operation of the information display apparatus and the information processing apparatus according to the embodiment 7 are basically similar to those of the information display apparatus 100 and the information processing apparatus 150 (see FIGS. 10 and 11) according to the embodiment 1. The difference lies in that the control over the display manner of the speedometer 11 performed by the speedometer display manner controlling unit 214 is based on the speed-related information.

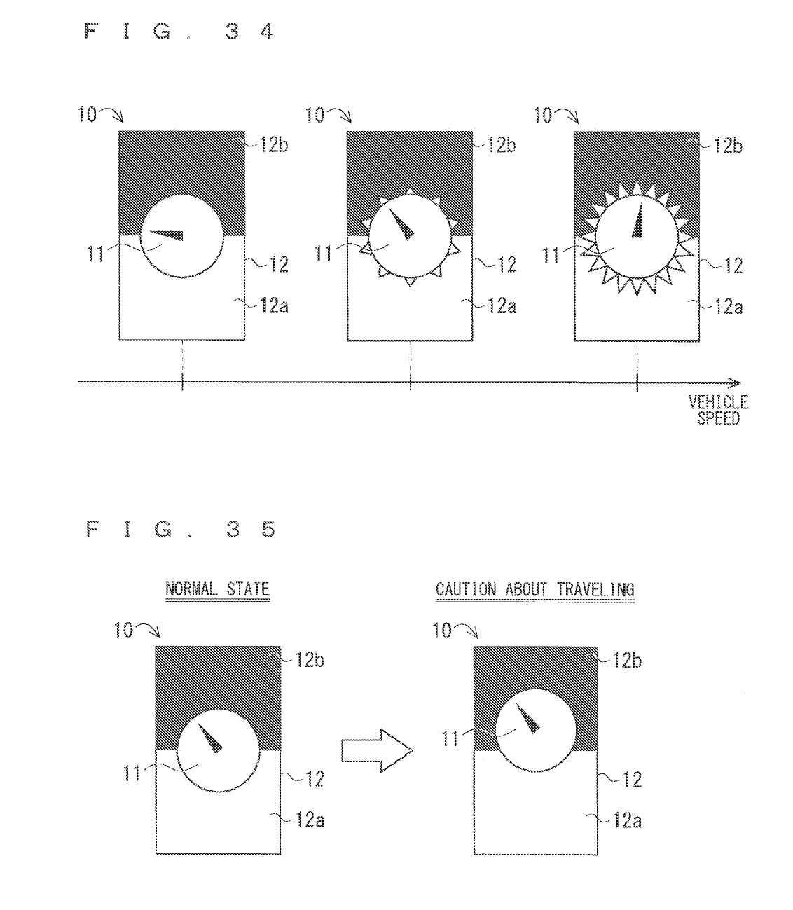

FIG. 32 shows an example of controlling the display manner of the speedometer 11 in accordance with the vehicle speed. In the example shown in FIG. 32, the dimension of the speedometer 11 increases with increasing vehicle speed. FIG. 33 shows an example of controlling the display manner of the speedometer 11 in accordance with the speed limit. In the example shown in FIG. 33, the dimension of the speedometer 11 decreases with increasing speed limit.

Alternatively, the dimension of the speedometer 11 can be controlled in accordance with both the vehicle speed and the speed limit. The display position of the speedometer 11 is not limited to the center of the background region 12 illustrated in FIGS. 32 and 33. The display position of the speedometer 11 is fixed in the examples shown in FIGS. 32 and 33. Alternatively, the embodiment 6 may be applied to move the speedometer 11.

The color of the speedometer 11 may be controlled in accordance with the speed-related information, whereby the display manner of the speedometer 11 is controlled. For example, hue of the speedometer 11 may be changed or at least one of lightness and saturation may be changed while hue is unchanged. At least one of the line width and the line style of the drawn line for the speedometer region 11 may be controlled in accordance with the speed-related information. The patterns may be added to the speedometer 11 in accordance with the speed-related information.

As illustrated in FIG. 34, the shape of the speedometer 11 (the shape of the ornament in this example) may be controlled in accordance with the speed-related information. This may be combined with the control over dimension and the like.

In the embodiment 7, the caution level about the vehicle speed and the changes in the caution level can be intuitively perceived through the display manner and the changes in the display manner of the speedometer 11.

The background region 12 includes the base region 12a and the notification region 12b. The presence of these regions 12a and 12b and the presence of their boundary serve as the guide for obtaining the display manner and the changes in the display manner of the speedometer 11. Thus, the position of and the changes in the position of the speedometer 11 can be easily perceived through the speedometer region 10.

As mentioned above, the speedometer region 10 can provide various display manners. A lot of information can be provided in an integrated manner through the various display manners. Thus, the user can obtain, along with the vehicle speed, other pieces of information (caution about the vehicle speed in this example) by looking at the speedometer region 10. This results in, for example, improved convenience.

The embodiment 7 may be combined with other embodiments.

### Embodiment 8

In an embodiment 8, the description is given on the example of controlling the display position and the display manner of the speedometer 11 in accordance with the road-related information on the road on which the vehicle is located. The embodiment 8 corresponds to the embodiment 5 of controlling the background region 12 in accordance with the road-related information.

The configuration and the operation of the information display apparatus and the information processing apparatus according to the embodiment 8 are basically similar to those of the information display apparatus 100B and the information processing apparatus 150B (see FIGS. 28 and 29) according to the embodiment 5. The difference lies in that at least one of the control over the display position of the speedometer 11 performed by the speedometer position controlling unit 213 and the control over the display manner of the speedometer 11 performed by the speedometer display manner controlling unit 214 is based on the speed-related information.

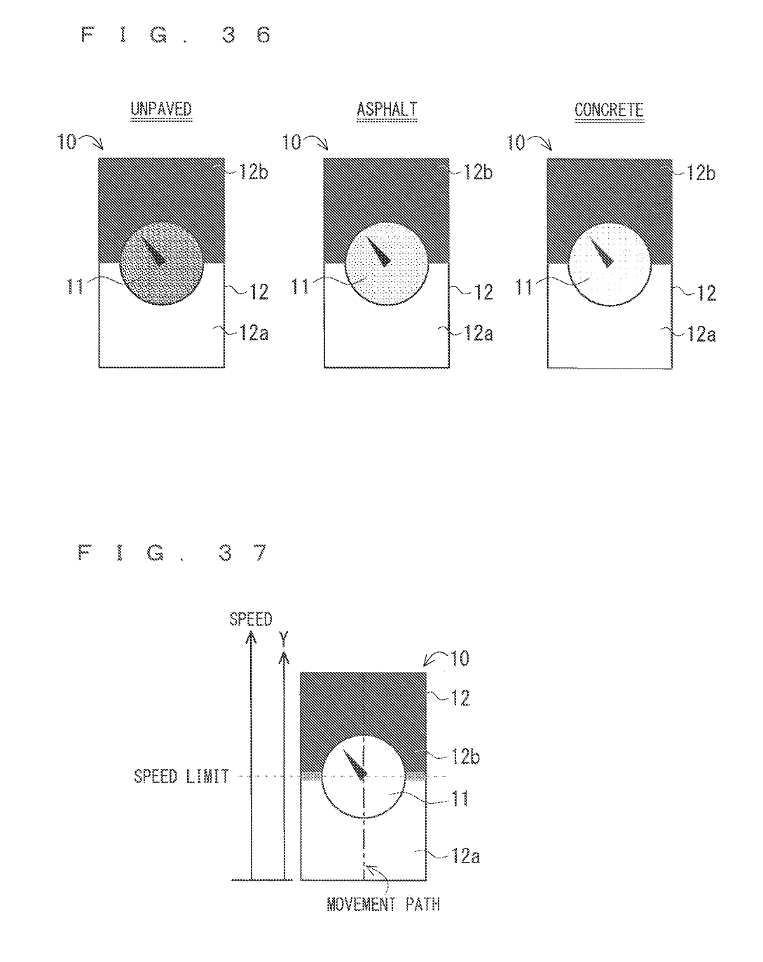

For example, as illustrated in FIG. 35, in a case where the detail of the road-related information suggests the need for caution about traveling, the display position of the speedometer region 11 is brought closer toward the above-mentioned distant edge of the notification region 12b (equivalent to the upper edge of the background region 12), compared with the display position in the normal state (the state with no reflection of the road-related information in this example). For example, with reference to the embodiment 5, the display position of the speedometer 11 includes the speed-related information associated section and the road-related information associated section.

The objects indicating the reflection of the road-related information may be displayed (see FIGS. 22 to 24).

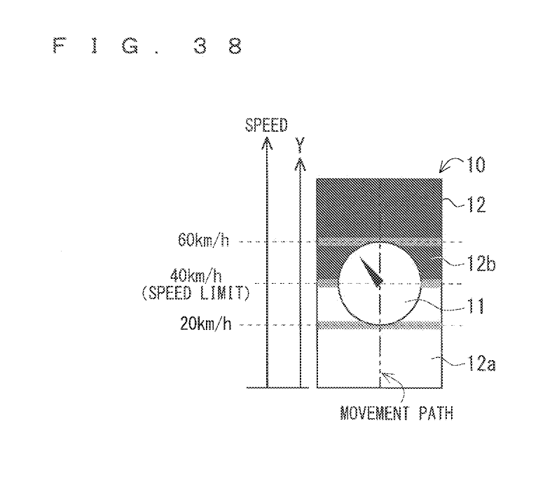

In a case where the road-related information refers to kinds of roads, the display manner of the speedometer 11 may be controlled in accordance with the kinds of roads. For example, as shown in FIG. 36, the speedometer 11 has different patterns for different roads including an unpaved road, a road paved with asphalt, and a road paved with concrete. In FIG. 36, the difference in pattern and the like is schematically indicated by the density of sand hatch.

Both the display position and the display manner of the speedometer 11 can be controlled in accordance with the road-related information by combining, for example, the controls illustrated in FIG. 35 and FIG. 36.

In the embodiment 8, at least one of the display position and the display manner of the speedometer 11 is controlled in accordance with the road-related information, further expanding the variety of the display manner of the speedometer region 10. This provides a wider variety of information to the user, thus resulting in, for example, improved convenience.

The embodiment 8 may be combined with other embodiments.

### Embodiment 9

The control over the background region 12, the control over the display position of the speedometer 11, and the control over the display manner of the speedometer 11 can be combined variously. In an embodiment 9, some examples of the combinations are described. The embodiment 9 can be implemented by the information display apparatus 100 or 100B mentioned above.

For example, in the control over the display position of the speedometer 11 as illustrated in FIG. 30, the display manner (such as color) of the speedometer region 11 may be also changed in accordance with the vehicle speed.

In the control over the display position of the speedometer 11 as illustrated in FIG. 30, the height of the notification region 12b may be changed in accordance with the maximum speed. In particular, in the example shown in FIG. 30, the notification region 12b is extended while the vehicle is traveling on an open road, and the notification region 12b is shortened while the vehicle is traveling on an expressway.

In the control over the display position of the speedometer 11 as illustrated in FIG. 30, a mark indicating the speed limit may be placed in the background region 12. As shown in FIG. 37, such mark is, for example, a line orthogonal to the movement path (see the alternate long and two short dashed line) of the speedometer 11. In particular, the background controlling unit 212 instructs the image generating unit 211 to bring the movement path of the speedometer 11 in the background region 12 into correspondence with the speed axis and to display the above-mentioned line at the position on the movement path corresponding to the speed limit.

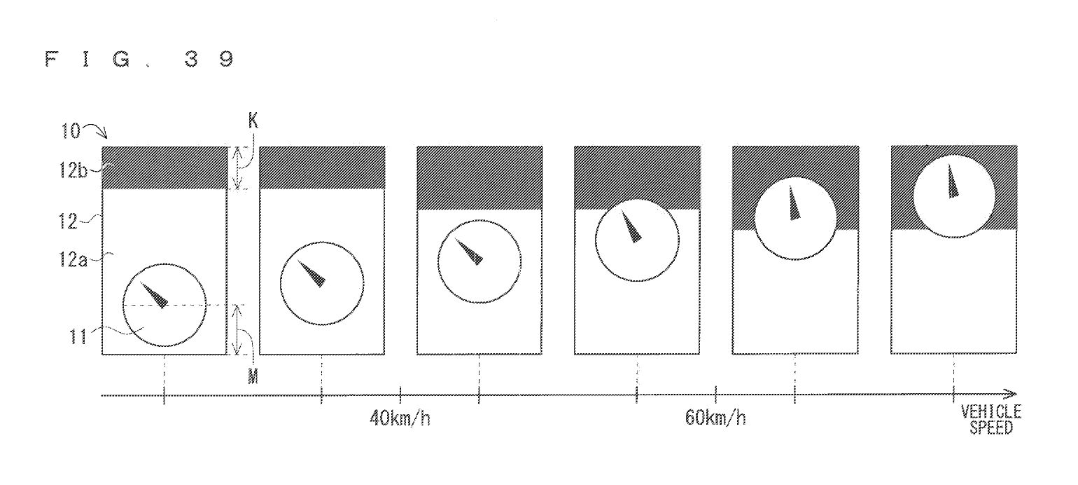

As shown in FIG. 38, the same sort of lines may be added to the position corresponding to the speed above the speed limit and the position corresponding to the speed below the speed limit. FIG. 38 illustrates the case in which the speed limit is 40 km/h, the speed above the speed limit is 60 km/h, and the speed below the speed limit is 20 km/h. The relation between the speed limit and the speed above and below the speed limit is defined in advance. For example, it is defined in advance that the speed obtained by adding 20 km/h to the speed limit is set as the above-mentioned speed above the speed limit and the speed obtained by subtracting 20 km/h from the speed limit is set as the above-mentioned below the speed limit.

FIGS. 39 to 44 illustrate the combinations of the control over the display position of the speedometer 11 and the control over the height of the notification region 12b. In these examples, as shown in FIG. 39, the display position of the speedometer 11 firstly moves closer toward the upper edge of the background region 12 as the vehicle speed increases. In this example, the display position of the speedometer 11 is expressed as a distance M between the center of the speedometer 11 and the lower edge of the background region 12 and is denoted by a display position M. A height dimension K (also simply referred to as a height K) of the notification region 12b increases with increasing vehicle speed.

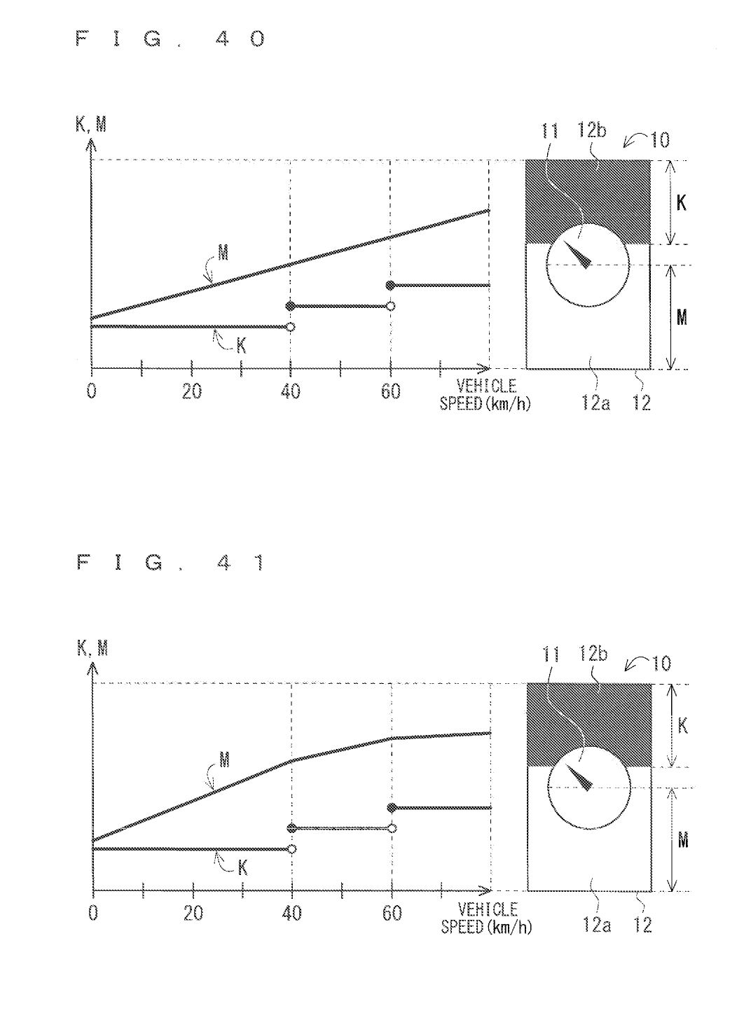

To be more specific, in the example shown in FIG. 40, the display position M of the speedometer 11 changes continuously, and accordingly, the speedometer 11 is displayed as if to move continuously. The display position M of the speedometer 11 is expressed as a linear function of the vehicle speed being the variable while the rate of change in the display position M is constant.

Meanwhile, the height K of the notification region 12b changes as with the solid characteristic line illustrated in FIG. 9. The range of change in vehicle speed is divided into the speed range of 0 to 40 km/h, the speed range of 40 to 60 km/h, and the speed range of 60 to 80 km/h. The height K of the notification region 12b changes discontinuously every time the speed range to which the vehicle speed belongs is shifted. Thus, the notification region 12b is displayed as if to change discontinuously (in other words, change in a discrete manner). The height K of the notification region 12b is unchanged within each speed range.

The information on which one of the speed ranges the vehicle speed belongs to may be generated in the background controlling unit 212 or may be generated in the speed-related information acquiring unit 200.

In the example shown in FIG. 40, the entirety of the speedometer 11 can fit in the notification region 12b. In a case where the height K of the notification region 12 b is unchanged and the height K of the notification region 12b is smaller than the height dimension of the speedometer 11, the speedometer 11 may overlap the notification region 12b but the entirety of the speedometer 11 does not fit in the notification region 12b. Thus, the display manners of the speedometer region 10 are limited. Meanwhile, the example shown in FIG. 40 can avoid the case where the entirety of the speedometer 11 does not fit in the notification region 12b, and thus, expand variety of the display manners of the speedometer region 10. Such effect can be also obtained in a case where the shape of the notification region 12b is changed continuously.

Through the discontinuous changes in the shape of the notification region 12b in the example shown in FIG. 40, which one of the speed ranges the vehicle belongs to can be easily perceived. In addition, the shifting to another speed range can be easily perceived.

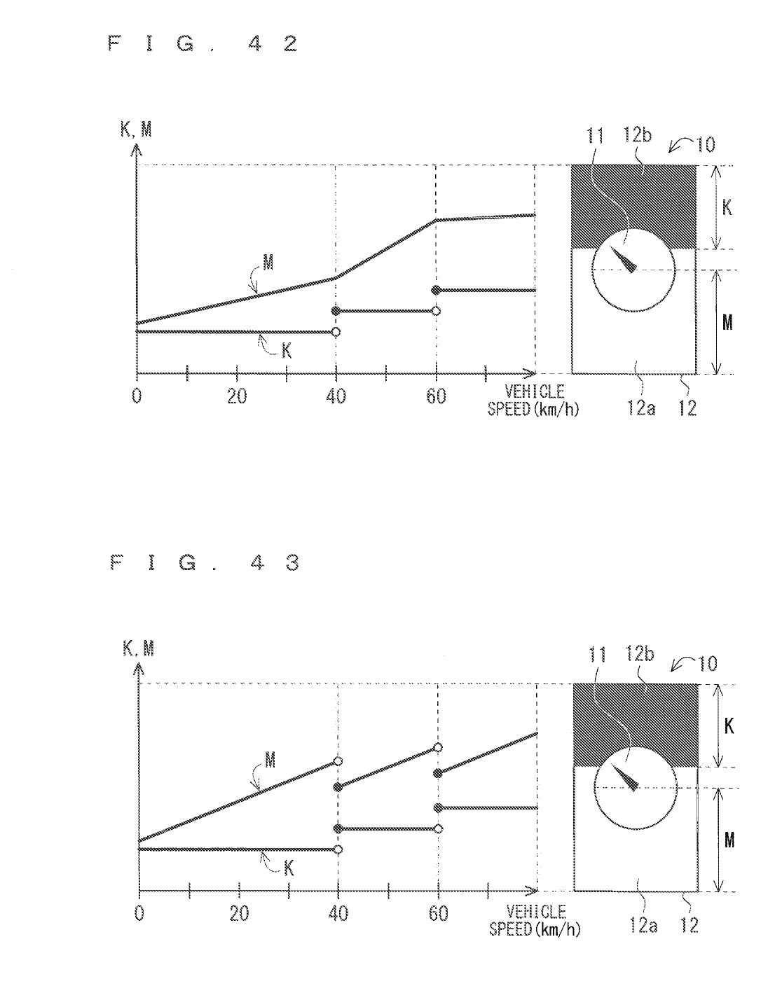

In the example shown in FIG. 41, the display position M of the speedometer 11 has different rates of change in different speedometer regions. That is, the display position M of the speedometer 11 changes at the position change rate preset for the speed range to which the vehicle speed belongs.

The information on which one of the speed ranges the vehicle speed belong to may be generated in the speedometer position controlling unit 213 or may be generated in the speed-related information acquiring unit 200.

In the example shown in FIG. 41, the entirety of the speedometer 11 can fit in the background region 12. If the rate of change in the display position M of the speedometer 11 is greater in the example shown in FIG. 40 mentioned above, the speedometer 11 would reach the upper edge of the background region 12 before the vehicle speed enters the high-speed zone. In other words, the range of the vehicle speed that can be displayed through the movement of the speedometer 11 is narrowed. Meanwhile, in the example shown in FIG. 41, the rate of change in the display position M of the speedometer 11 is dynamically changed, thus expanding the range of the vehicle speed that can be displayed through the movement of the speedometer 11.

In the example shown in FIG. 41, a greater value is set as the rate of change in the display position M of the speedometer 11 in the speed range of 0 to 40 km/h. In the example shown in FIG. 42, a greater rate of change is set for the speed range of 40 to 60 km/h. In a case where the speed limit falls within the speed range of 40 to 60 km/h, the example shown in FIG. 42 can expand the movement of the speedometer 11 at around the speed limit. Thus, the fact that the vehicle is traveling at around the speed limit can be easily perceived, which aids in calling attention to the vehicle speed.

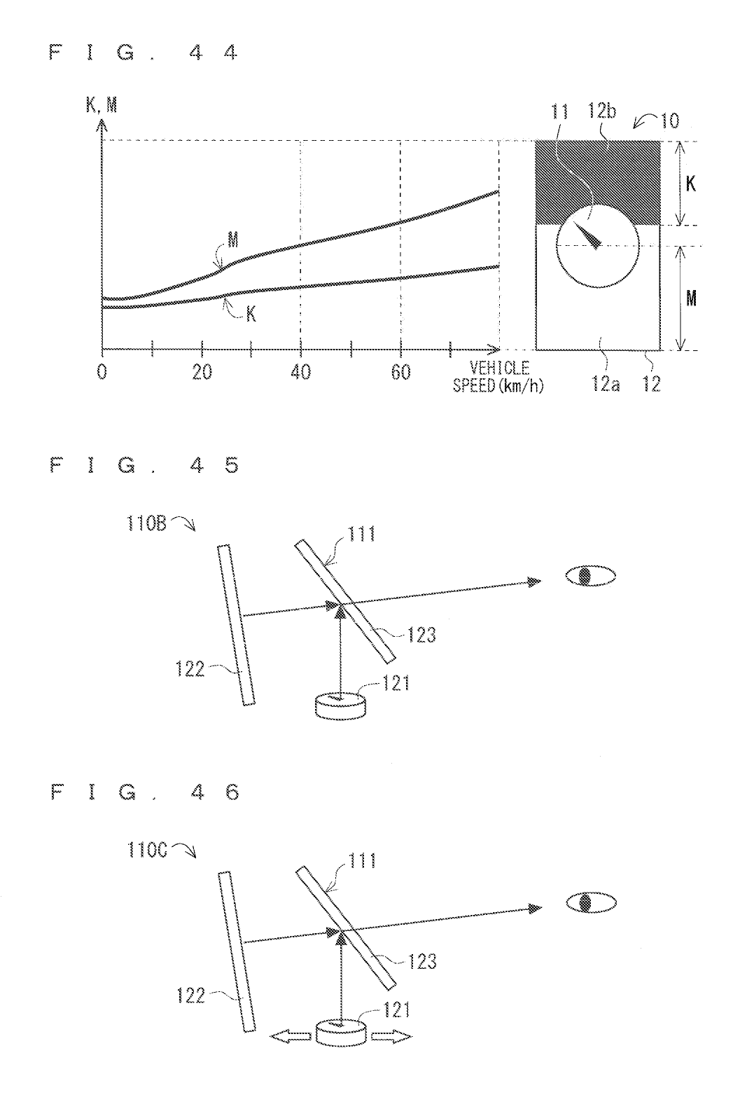

In the example shown in FIG. 43, the display position M of the speedometer 11 changes discontinuously every time the speed range to which the vehicle speed belongs is shifted. Thus, at the moment of shifting, the speedometer 11 is displayed as if to move discontinuously (in other words, move in a discrete manner).

In the example shown in FIG. 43, every time the speed range to which the vehicle speed belongs is shifted, the display position M of the speedometer 11 regresses (or equivalently, moves toward the lower edge of the background region 12), and then, the display position M of the speedometer 11 continues to move.

In the example shown in FIG. 43, the display position M of the speedometer 11 changes continuously within each speed range. The rate of change in the display position M of the speedometer 11 is constant regardless of which one of the speed ranges the vehicle speed belongs to.

In the example shown in FIG. 43, the recycled use of the background region 12 expands the range of the vehicle speed that can be displayed through the movement of the speedometer 11. This can eliminate the above-mentioned problem associated with the narrowed range of vehicle speed that can be displayed through the movement of the speedometer 11, even if the rate of change in the display position M of the speedometer 11 is set at a greater value. In other words, the degree of flexibility in setting the rate of change in the display position M of the speedometer 11 is increased.

In the examples shown in FIGS. 41 to 43, the individual characteristic lines indicating the display position M of the speedometer 11 are straight lines. Alternatively, part or all of the characteristic lines in each speed range may be formed of curved lines. The rate of change in the curved part of the display position M is given by, for example, the preset function formula.

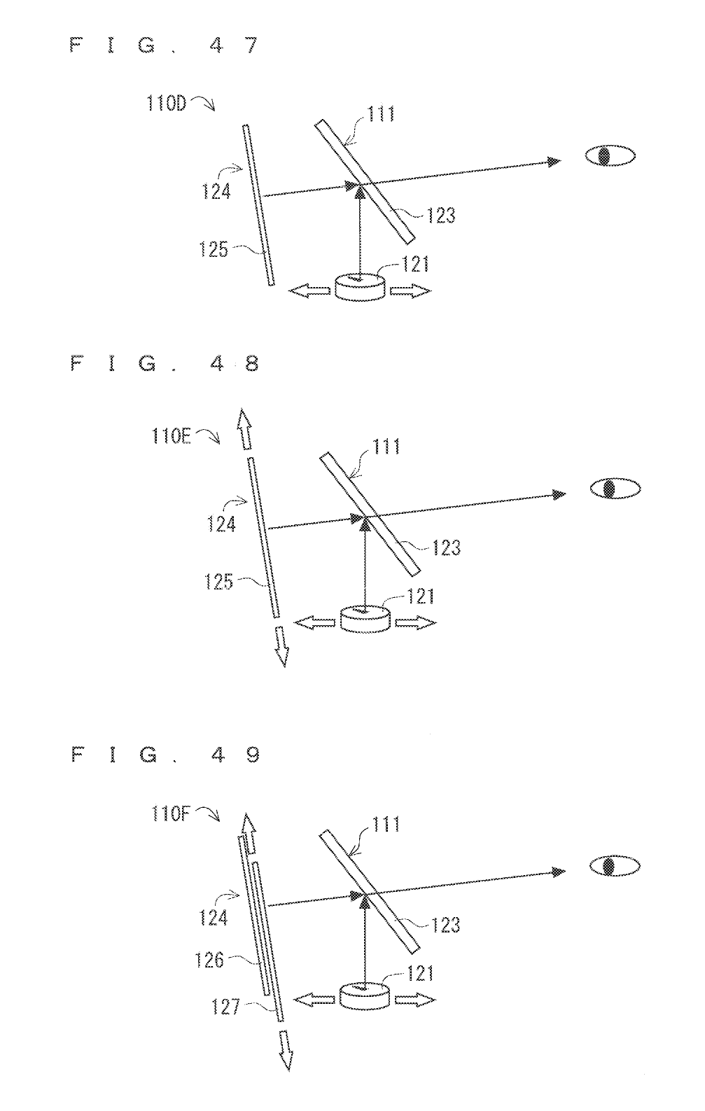

In the example shown in FIG. 44, both the display position M of the speedometer 11 and the height K of the notification region 12b change continuously at a mild pace. Such control is suitable for users who do not prefer discontinuous changes.

### Embodiment 10

In an embodiment 10, the description is given on modifications of the display apparatus 110 (see FIG. 10). The display apparatus 110 being a liquid crystal display apparatus has been described above as an example. In this example, the image of the speedometer region 10, or equivalently, the images of the speedometer 11 and the background region 12 are rendered on the screen 111 of the liquid crystal display apparatus. In the embodiment 10, meanwhile, the following describes the example in which at least one of the image of the speedometer 11 appearing on the screen 111 and the image of the background region 12 appearing on the screen 111 is realized by a projected image of the actual apparatus. FIGS. 45 to 49 are conceptual illustrations of the display apparatuses according to the embodiment 10.

A display apparatus 110B illustrated in FIG. 45 includes an actual speedometer apparatus 121 (also simply referred to as a speedometer apparatus 121), an image display apparatus 122, and a half mirror 123. The actual speedometer apparatus 121 is a vehicle-installed speedometer and displays the vehicle speed. The image display apparatus 122 is, for example a liquid crystal display apparatus and displays the image of the background region 12. The image of the actual speedometer apparatus 121 and the image of the background region 12 displayed on the image display apparatus 122 enter (in other words, are projected on) the half mirror 123 and are optically composed by the half mirror 123. In this respect, the half mirror 123 is regarded as an example of optical composing apparatuses.

The above-mentioned two images are optically composed by the half mirror 123, so that the speedometer region 10 including the speedometer 11 realized by the projected image of the actual speedometer apparatus 121 appears on the half mirror 123. At this time, the half mirror 123 provides the screen 111 that displays the speedometer region 10.

The display apparatus 110B can provide the screen design giving a stereoscopic view of the speedometer 11. This eliminates the need for generating the image data of the speedometer 11, and the processing of the image generating unit 211 is lessened accordingly.

The positions of the speedometer apparatus 121 and the image display apparatus 122 are not limited to the positions in the example shown in FIG. 45. In the display apparatus 110B, the speedometer apparatus 121 is fixed, and thus, the speedometer 11 dose not move on the screen 111. From this regard, the speedometer position controlling unit 213 may be omitted from the information processing apparatuses 100 and 100B (see FIGS. 10 and 28). The actual speedometer apparatus 121 provides no change in the display manner of the speedometer 11 on the screen 111. From this regard, the speedometer display manner controlling unit 214 may be omitted.

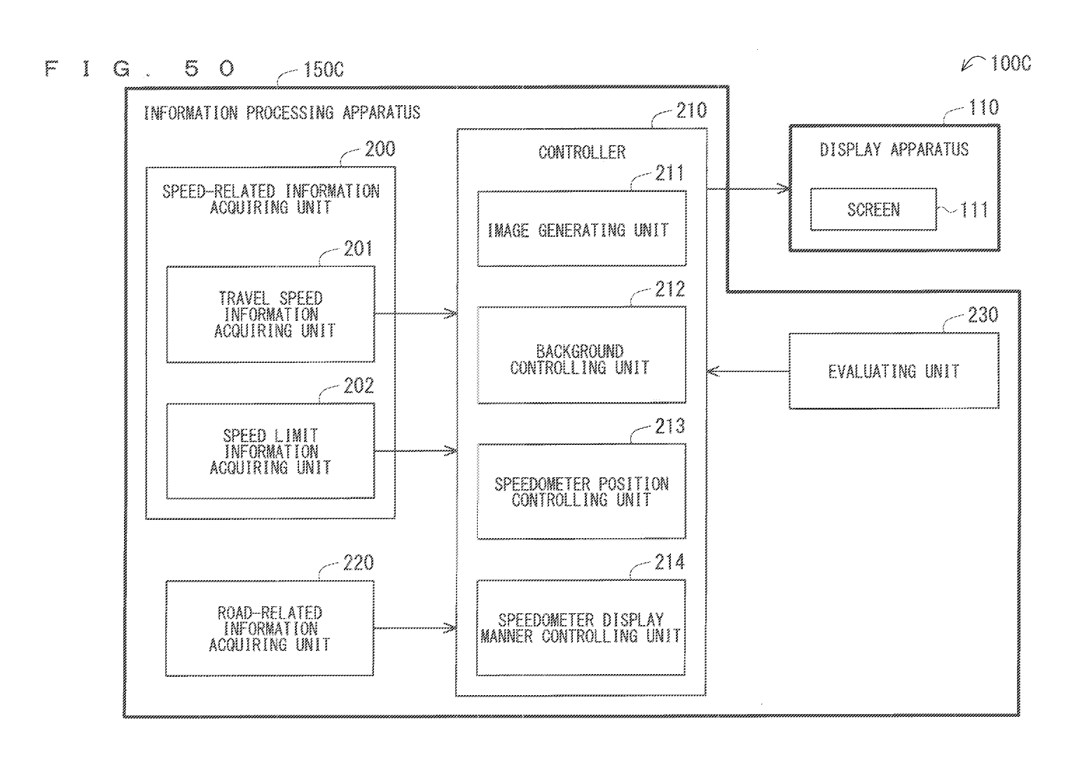

A display apparatus 110C illustrated in FIG. 46 is basically similar to the display apparatus 110B mentioned above except that the actual speedometer apparatus 121 is movable. For example, the sliding mechanism that slides the speedometer apparatus 121 in the preset directions is provided. The sliding mechanism is controlled by the speedometer position controlling units 213 of the information processing apparatuses 100 and 100B. Thus, the actual speedometer apparatus 121 moves, and accordingly, the display position of the speedometer 11 on the screen 111 is changed.

A display apparatus 110D illustrated in FIG. 47 has the configuration in which the image display apparatus 122 in the display apparatus 110C mentioned above is replaced by a background apparatus 124. The background apparatus 124 is the actual apparatus corresponding to the image of the background region 12. In particular, the background apparatus 124 includes a member 125 having a surface on which the background region 12a and the notification region 12b are drawn. The member 125 is hereinafter referred to as a background member 125. In a case where the background member 125 is a plate material as illustrated in FIG. 47, the member 125 may be also referred to as a background plate 125.

In the display apparatus 110D, the image of the background region 12 drawn on the background member 125 are optically composed with the image of the actual speedometer apparatus 121 by the half mirror 123. The speedometer region 10 accordingly appears on the screen 111.

The cost (in other words, price) of the display apparatus 110D can be reduced relative to the display apparatuses 110B and 110C including the image display apparatuses 122.

The positions of the speedometer apparatus 121 and the background apparatus 124 are not limited to the positions in the example shown in FIG. 47. In the display apparatus 110D, the background member 125 is fixed, and thus, the background region 12 does not change on the screen 111. From this regard, the background controlling unit 212 may be omitted from the information processing apparatuses 100 and 100B (see FIGS. 10 and 28). There is no need to generate the image data of the speedometer 11 and the background region 12, and thus, the image generating unit 211 may be omitted.

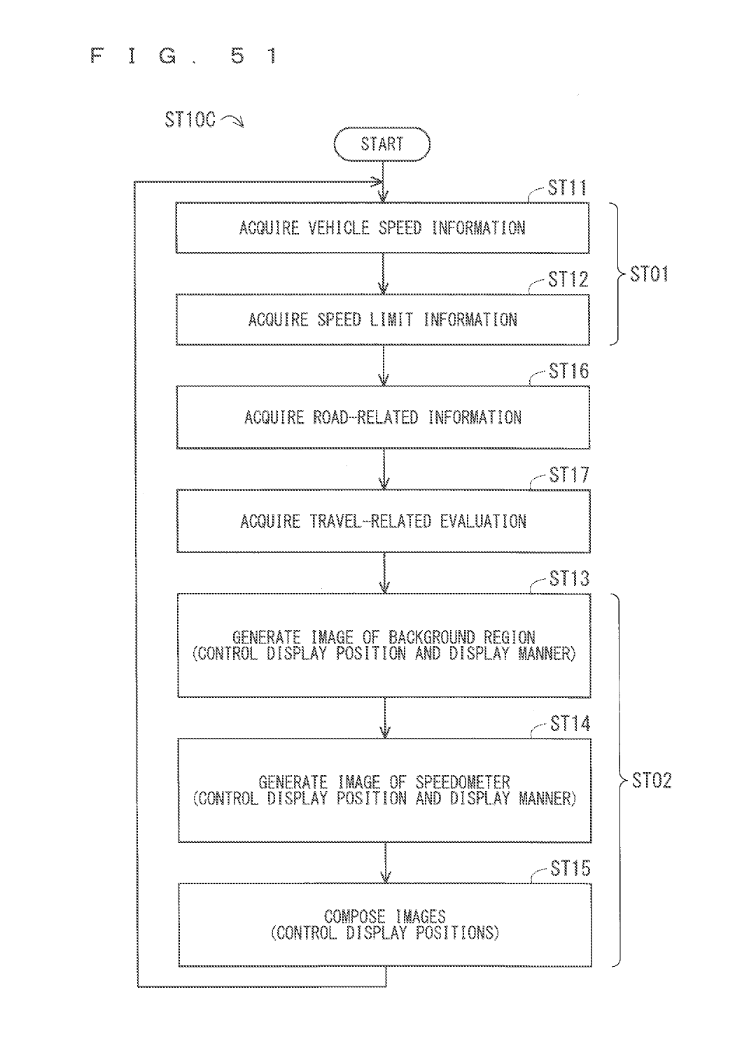

A display apparatus 110E illustrated in FIG. 48 is basically similar to the display apparatus 110D mentioned above except that the background member 125 is movable. For example, the sliding mechanism that slides the background member 125 in the preset directions is provided. The sliding mechanism is controlled by the background controlling units 212 of the information processing apparatuses 100 and 100B. The background member 125 moves, and accordingly, the display manner of the background region 12 on the screen 111 is changed.

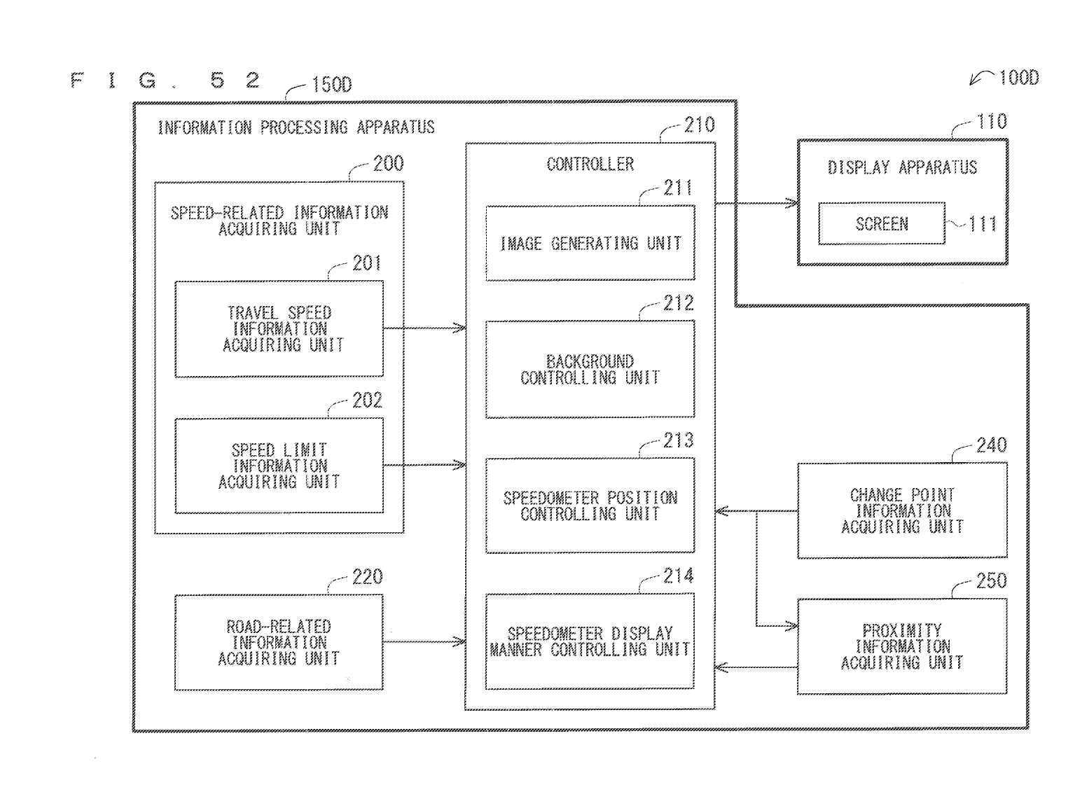

A display apparatus 110F illustrated in FIG. 49 is basically similar to the display apparatuses 110D and 110E except that the background apparatus 124 includes two background members 126 and 127. The color of the surface of the first background member 126 is the same as the color of the base region 12a. The color of the surface of the second background member 127 is the same as the color of the notification region 12b. The positions of the background member 126 and the background member 127 in the example shown in FIG. 49 may be reversed.

As with the background member 125 mentioned above, at least one of the background members 126 and 127 is movable. Thus, the relative positions of the background members 126 and 127 are controllable. The background controlling unit 212 changes the relative positions of the background members 126 and 127, and accordingly, the display manner of the background region 12 on the screen 111 is changed.

The background apparatuses 124 in FIGS. 48 and 49 may be applied to the display apparatus 110B in FIG. 45 including the actual speedometer apparatus 121 fixed thereto.

The displaying method implemented by the display apparatuses 110B to 110F may be also referred to as, for example, the optical composing method and the half mirror method.

For the optical arrangement in the embodiment 10, the image display apparatus 122 (see FIGS. 45 and 46) is located on the inner side and the actual speedometer apparatus 121 is located on the lower side. Alternatively, the image display apparatus 122 may be located on the lower side and the actual speedometer apparatus 121 may be located on the inner side. Still alternatively, another one of the actual speedometer apparatus 121 may be located on the lateral side and the half mirror 123 may be inclined rightward or leftward such that the speedometer apparatuses 121 on the lateral side and on the inner side appear as if to overlap each other. This increases the flexibility in selecting the arrangements of the actual speedometer apparatus 121, offering a wide choice of mechanism designs for the display apparatus 110B and the like.

### Embodiment 11

In the embodiments 1 to 10 mentioned above, the description has been given on the examples of calling attention to the vehicle speed through the display manner of the speedometer region 10 on the screen 111. The display manner of the speedometer region 10 is also applicable to other uses. For example, the display manner of the speedometer region 10 can provide notifications about the evaluation related to traveling (hereinafter referred to as a travel-related evaluation) including the evaluation of the economical driving (so-called eco-driving) of the vehicle, the evaluation of the possibility of reaching the closest fueling station, and the like.

FIG. 50 is a block diagram of an information display apparatus 100C according to an embodiment 11. In the example shown in FIG. 50, the information display apparatus 100C includes the display apparatus 110 and an information processing apparatus 150C. The display apparatus 110 can be replaced by any one of the display apparatuses 110B to 110F (see FIGS. 45 to 49). The information processing apparatus 150C according to the embodiment 11 has the configuration in which an evaluation unit 230 is added to the information processing apparatus 150B mentioned above (see FIG. 28).

The evaluation unit 230 acquires the travel-related evaluation on the basis of the vehicle speed. The travel-related evaluation is obtained by, for example, applying the information on the vehicle speed (such as the value of the vehicle speed) acquired by the travel speed information acquiring unit 201 to the travel-related evaluation rule defined in advance with the vehicle speed as the input parameter.

If the information other than the vehicle speed is required for the travel-related evaluation, the evaluation unit 230 acquires the necessary information. For example, if the speed limit information is required, the evaluation unit 230 acquires the speed limit information from the speed limit information acquiring unit 202. Similarly, if the road-related information is required, the evaluation unit 230 acquires the road-related information from the road-related information acquiring unit 220. The road-related information associated with the eco-driving includes the road shapes, the road gradients, and the like. In other words, if the speed limit information is not necessary for the travel-related evaluation, the speed limit information acquiring unit 202 may be omitted with regard to the acquisition of the travel-related evaluation. The same holds true for the road-related information acquiring unit 220.

The travel-related evaluation acquired by the evaluation unit 230 is supplied to the controller 210, and then, the controller 210 controls the display manner of the speedometer region 10 on the screen 111 in accordance with the travel-related evaluation. In particular, the controller 210 controls at least one of the display manner of the notification region 12b, the display position of the speedometer 11 in the background region 12, and the display manner of the speedometer 11 in accordance with the travel-related evaluation.

The travel-related evaluation (or equivalently, the evaluation result) is expressed as the evaluation level. For example, the dimension of the notification region 12b in the preset direction is accordingly increased as the evaluation level is raised. The display position of the speedometer 11 is brought closer toward the above-mentioned distant edge of the notification region 12b as the evaluation level is raised.

There should be a predetermined correlation relating to whether the evaluation level is raised or lowered as the travel-related evaluation improves (in other words, the evaluation level is raised or raised as the travel-related evaluation deteriorates).

In particular, in a case where the notification region 12b indicates the degree of achievement of objectives, the evaluation value that is raised with improving travel-related evaluation is in touch with general sensibilities. The degree of achievement of objectives refers to, for example, the evaluation of the degree of conformity to the economical driving and the possibility of reaching the closest fueling station. In this case, the color of the notification region 12b is preferably the color (such as, blue or green) that provides safety.

Conversely, in a case where the notification region 12b indicates caution, the evaluation level that is raised with deteriorating travel-related evaluation is in touch with general sensibilities. The caution refers to, for example, the evaluation of discrepancy with the economical driving and the possibility of failing to reach the closest fueling station. In this case, the color of the notification region 12b is preferably the color (such as, red or yellow) for calling attention.

The specific control over the display manner of the speedometer region 10 is achieved through the adoption of the embodiments 1 to 10, and thus, the description thereof is not repeated.

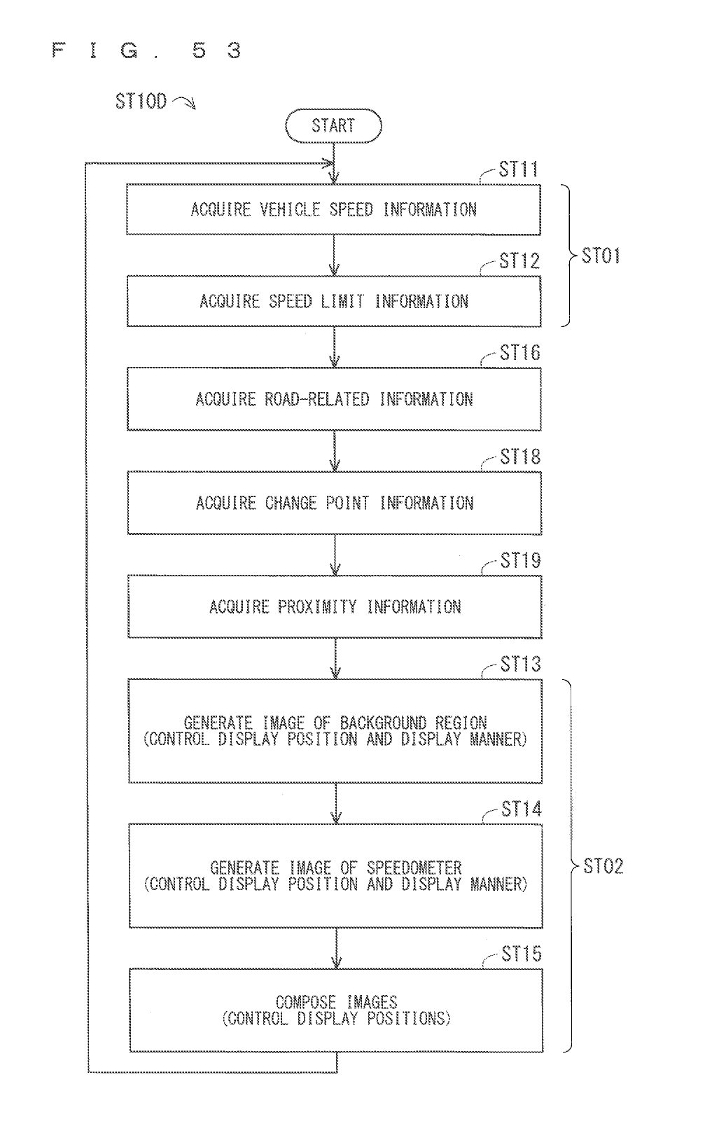

FIG. 51 is a flowchart describing the operation of the information processing apparatus 150C. An operational flow ST10C illustrated in FIG. 51 is the flow in which step ST17 of acquiring the travel-related evaluation is added to the operational flow ST10B illustrated in FIG. 29.

In the example shown in FIG. 51, step ST17 is performed between step ST16 of acquiring the road-related information and step ST13 of generating the image of the background region. It is only required that step ST17 be performed before step ST02 of controlling the display manner of the speedometer region 10.

If the speed limit information is not necessary for the travel-related evaluation, step ST12 of acquiring the speed limit information may be omitted. The same holds true for step ST16 of acquiring the road-related information.

The embodiment 11 can produce various kinds of effects described in the embodiments 1 to 10 with regard to the displaying of the travel-related evaluation.

### Embodiment 12

In an embodiment 12, the following describes other application examples of the control over the display manner of the speedometer region 10.

FIG. 52 is a block diagram of an information display apparatus 100D according to the embodiment 12. In the example shown in FIG. 52, the information display apparatus 100D includes the display apparatus 110 and an information processing apparatus 150D. The display apparatus 110 can be replaced by any one of the display apparatuses 110B to 110F (see FIGS. 45 to 49). The information processing apparatus 150D according to the embodiment 12 has the configuration in which a change point information acquiring unit 240 and a proximity information acquiring unit 250 are added to the information processing apparatus 150B mentioned above (see FIG. 28).

The change point information acquiring unit 240 acquires the information (hereinafter referred to as change point information) related to the change point being the point at which there is a change in the path environment associated with the expected travel path for the vehicle.

The information on the expected travel path for the vehicle can be acquired in the following manner. In a case where a navigation path is set by the navigation function, the navigation path (more specifically, the path ahead of the current position on the navigation path) can be adopted as the expected travel path. In a case where no navigation path is set, the road on which the vehicle is currently located (more specifically, the following road located ahead) can be adopted as the expected travel path.

The path environment refers to the environment associated with the expected travel path. The information on the path environment includes, for example, the speed limit information and the road-related information. Thus, the change in the path environment can be determined through at least one of the change in the speed limit information and the change in the road-related information. For example, the map database is searched for the information on the path environment along the expected travel path, so that changes in the path environment and the corresponding change points can be determined.

The change point information includes the information on the types of the changing path environment (or equivalently, the information on which one of the details of the path environment changes) and the position information of the change point. These two pieces of information are correlated with each other. In the example shown in FIG. 52, the change point information is supplied to the proximity information acquiring unit 250 and the controller 210.

The proximity information acquiring unit 250 acquires the information (hereinafter referred to as proximity information) related to the own vehicle's proximity to the change point.

The proximity information is related to the difference between the current position information of the own vehicle and the position information of the change point. Such difference is, for example, a spatial difference (in other words, a difference in distance). If this is the case, the proximity information is displayed as the remaining distance from the current position to the change point. Alternatively, the above-mentioned difference may be a temporal difference. If this is the case, the proximity information is displayed as the expected time required for arrival at the change point. The proximity information may include both the information on the spatial difference and the information on the temporal difference.

The proximity information is supplied to the controller 210, and then, the controller 210 controls the display manner of the speedometer region 10 on the screen 111 in accordance with the proximity information.

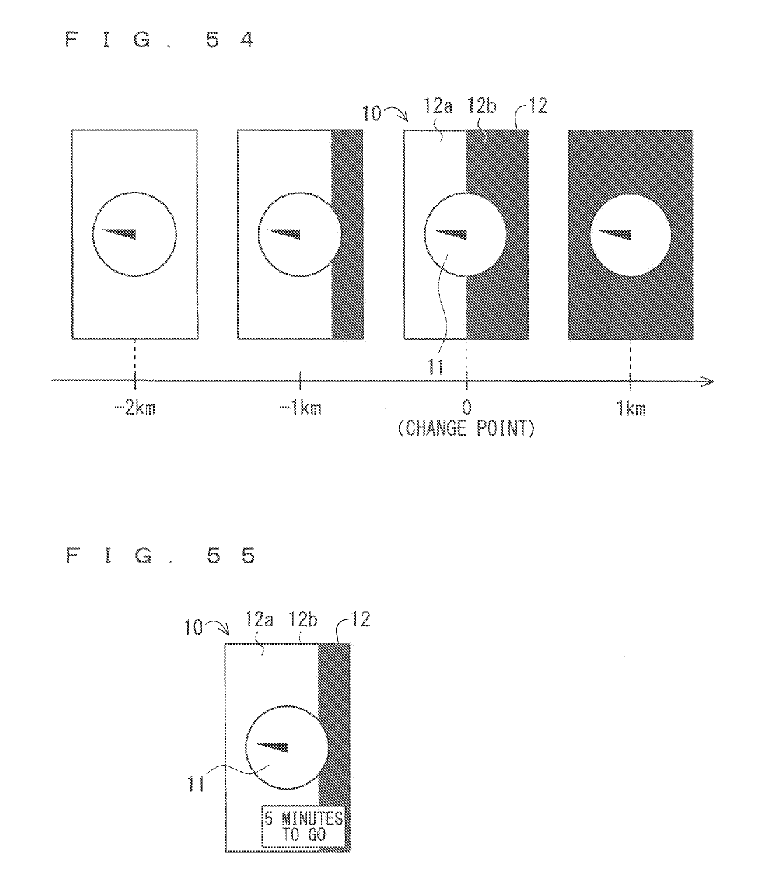

FIG. 53 is a flowchart describing the operation of the information processing apparatus 150D. An operational flow ST10D illustrated in FIG. 53 is the flow in which step ST18 of acquiring the change point information and step ST19 of acquiring the proximity information are added to the operational flow ST10B illustrated in FIG. 29.

In the example illustrated in FIG. 53, steps ST18 and ST19 are performed between step ST16 of acquiring the road-related information and step ST13 of generating the image of the background region. It is only required that steps ST18 and ST19 be performed before step ST13 of generating the image of the background region.

If the speed limit information is not necessary for the acquisition of the change point information and the proximity information, step ST12 of acquiring the speed limit information may be omitted. The same holds true for step ST16 of acquiring the road-related information.

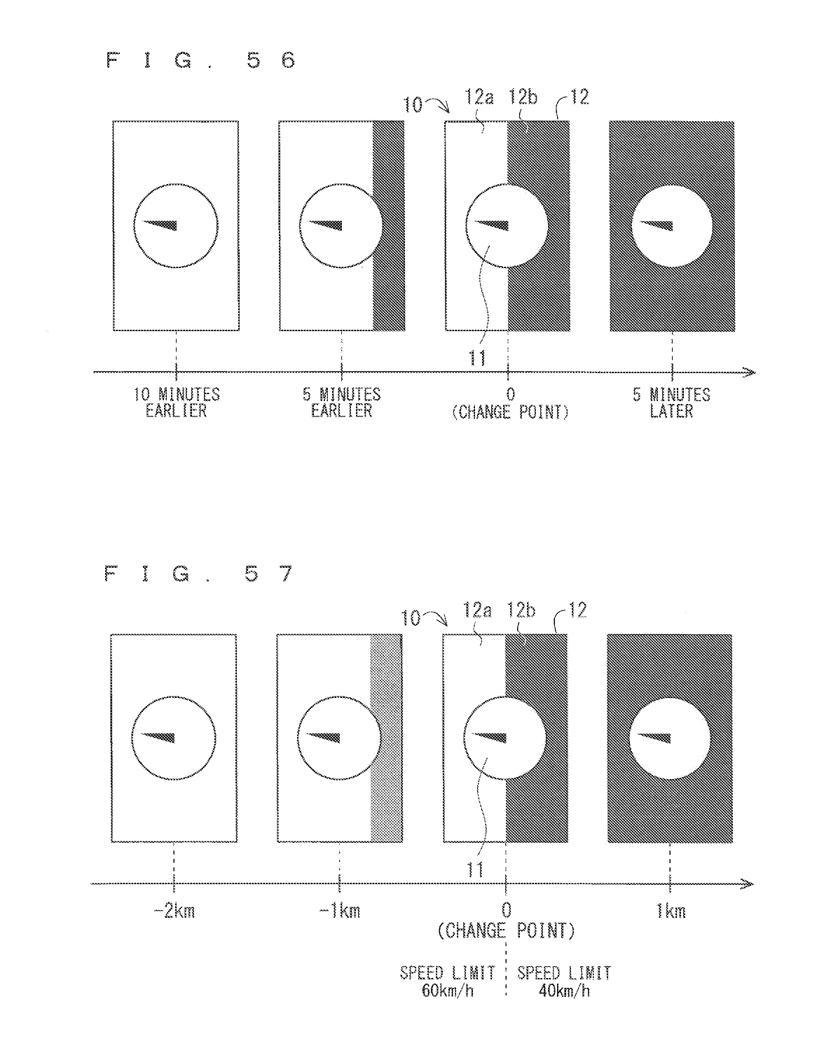

FIGS. 54 to 65 illustrate examples of control over the display manner of the speedometer region 10.

In the example shown in FIG. 54, the width (or equivalently, the dimension in the horizontal direction) of the notification region 12b is controlled in accordance with the reaming distance to the change point. In particular, the notification region 12b appears on the screen 111 when the remaining distance equates to the preset distance. Then, the width of the notification region 12b increases (or equivalently, the notification region 12b extends in the horizontal direction) as the remaining distance decreases.

In the example shown in FIG. 54, the notification region 12b is controlled not to extend for the full width of the background region 12 when the vehicle arrives at the change point. Thus, even after the vehicle's passage through the change point, the extension of the notification region 12b is continued until the vehicle runs for a preset distance away from the change point. Alternatively, the notification region 12b may be controlled to extend for the full width of the background region 12 when the vehicle arrives at the change point.

In the example shown in FIG. 55, the expected time required for arrival at the change point is displayed for the example in FIG. 54. The expected time required for arrival may be displayed on the screen 111 on which the speedometer region 10 is displayed. Alternatively, the expected time required for arrival may be displayed on another screen (such as a head-up display). In a case where the expected time required for arrival is displayed on another screen, the image generating unit 211 also generates the image data for the other screen and writes the generated image data into the image holding unit for the other screen.

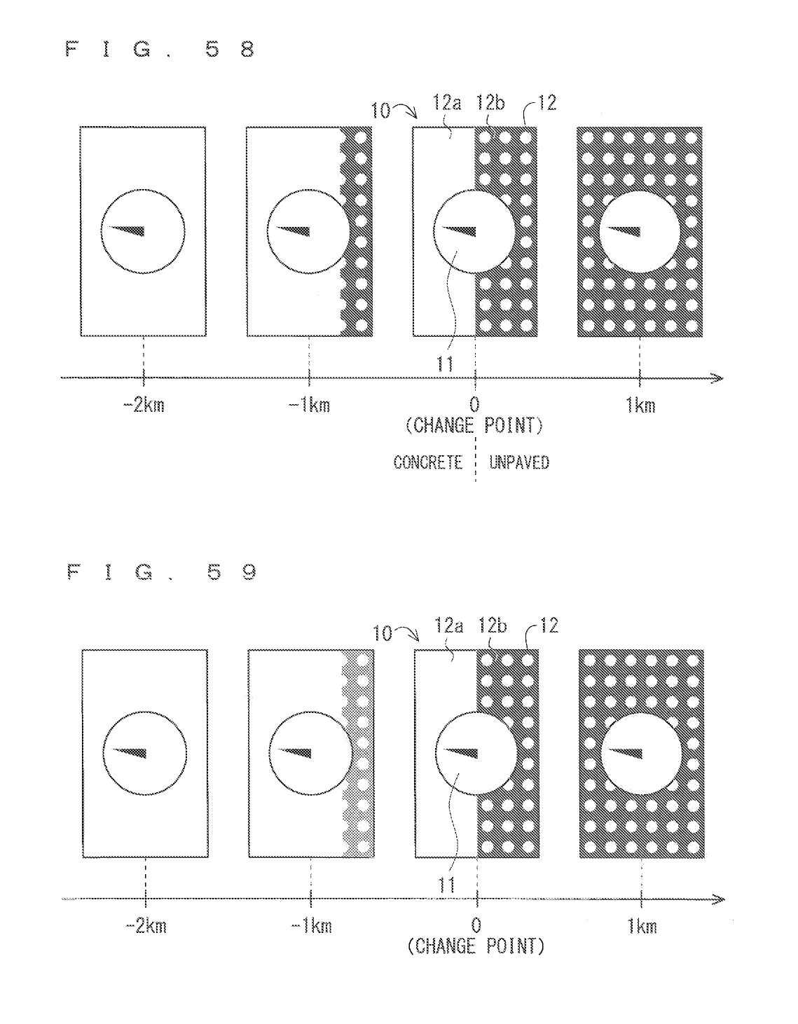

In the example shown in FIG. 56, the width of the notification region 12b is controlled in accordance with the expected time required for arrival at the change point. In particular, the notification region 12b appears when the expected time required for arrival equates to the preset time. Then, the width of the notification region 12b increases as the expected time required for arrival decreases. In the example shown in FIG. 56 as well, the width of the notification region 12b at the time of arrival at the change point can be adjusted through the setting.

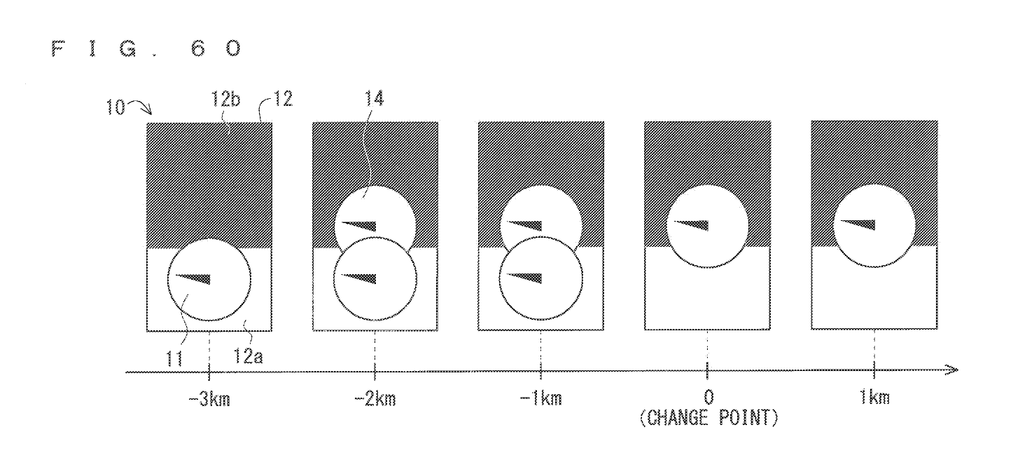

FIGS. 57 to 59 illustrate the examples of controlling the display manner of the notification region 12b in accordance with the path environment that changes at the change point.

In the example shown in FIG. 57, a notification of expected overspeed associated with the change in the speed limit at the change point is provided through the color of the notification region 12b. Assume that the current vehicle speed stands at 50 km/h and the speed limit is changed from 60 km/h to 40 km/h. If the current vehicle speed is maintained, it would be regarded as an overspeed after the vehicle's passage through the change point. The background controlling unit 212 compares the changed speed limit with the current vehicle speed and sets a color different from the default as the color of the notification region 12b upon receipt of the comparison result indicating that the current vehicle speed is greater than the changed speed limit.

Alternatively, as the remaining distance decreases, the color of the notification region 12b is changed to the color for the higher caution level. For example, the color is changed continuously from yellow to red.

In place of the color or in addition to the color, the pattern may be controlled.

In the example shown in FIG. 58, the change in the kinds of roads at the change point is notified through the pattern of the notification region 12b. In place of the pattern or in addition to the pattern, the color may be controlled.

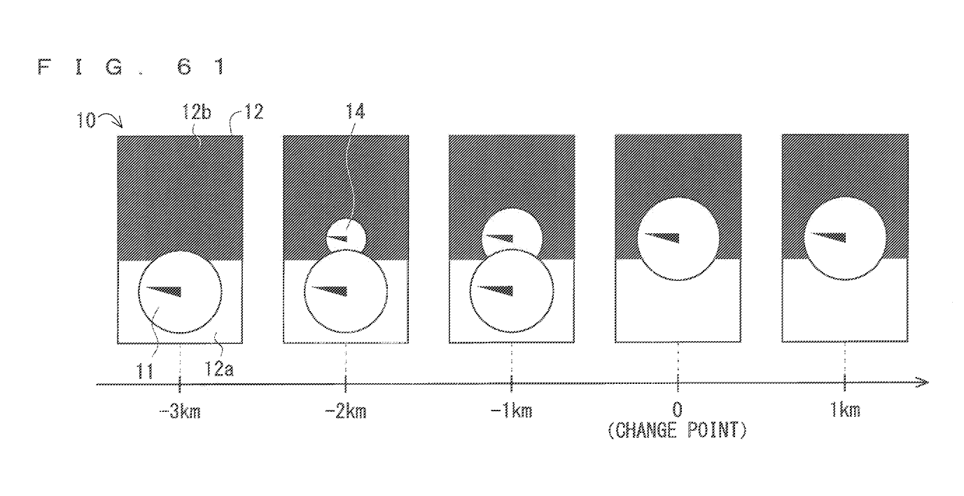

The example in FIG. 59 is a combination of the example in FIG. 57 and the example in FIG. 58.

In the example shown in FIG. 60, the display manner of the speedometer is controlled in accordance with the proximity information. In particular, when the remaining distance equates to the preset distance, a speedometer 14 that is separate from the speedometer 11 appears on the screen 111. When the vehicle arrives at the change point, the speedometer 11 that has been originally displayed is deleted from the screen 111 while the other speedometer 14 is left as it is.

The speedometer 11 that has been originally displayed may be also referred to as a first speedometer 11 and the other speedometer 14 that is subsequently displayed may be also referred to as a second speedometer 14.

In the example shown in FIG. 60, the two speedometers 11 and 14 overlap each other in such a manner that the second speedometer 14 underlies the first speedometer 11. Alternatively, the two speedometers 11 and 14 may be superimposed in the order reverse to the order in the example shown in FIG. 60.

In a case where the 3D naked eye stereoscopic display apparatus is used, the floating position (or equivalently, the position on the Z axis described above) of the second speedometer 14 at the time of appearance may be different from the floating position of the first speedometer 11 (in the example shown in FIG. 60, the first speedometer 11 floats on the near side), and then, the second speedometer 14 may move closer to the floating position of the first speedometer 11 as the vehicle approaches the change point.

In the example shown in FIG. 60, the display position of the second speedometer 14 may be at a preset distance away from the display position of the first speedometer 11. Alternatively, in a case where the path environment that changes at the change point is the speed limit, the display position of the first speedometer 11 may be controlled in accordance with the speed limit at the current position and the display position of the second speedometer 14 may be controlled in accordance with the changed speed limit.

The second speedometer 14 may be displayed at the preset position right from the time of appearance. Alternatively, for example, the second speedometer 14 may appear from behind the first speedometer 11 through the use of animation.

While the two speedometers 11 and 14 are concurrently displayed, the display manner of the speedometer 14 may be different from the display manner of the first speedometer 11. After the first speedometer 11 is deleted, the display manner of the second speedometer 14 may be changed to the display manner of the first speedometer 11.

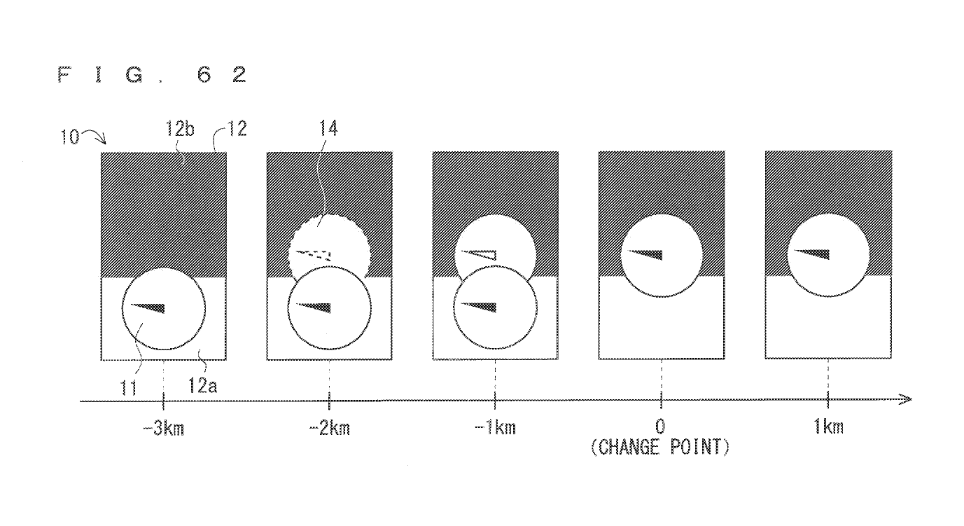

FIGS. 61 to 63 illustrate the examples of controlling the display manner of the second speedometer 14 for the example shown in FIG. 60.

In the example shown in FIG. 61, the dimension of the second speedometer 14 increases as the remaining distance decreases.

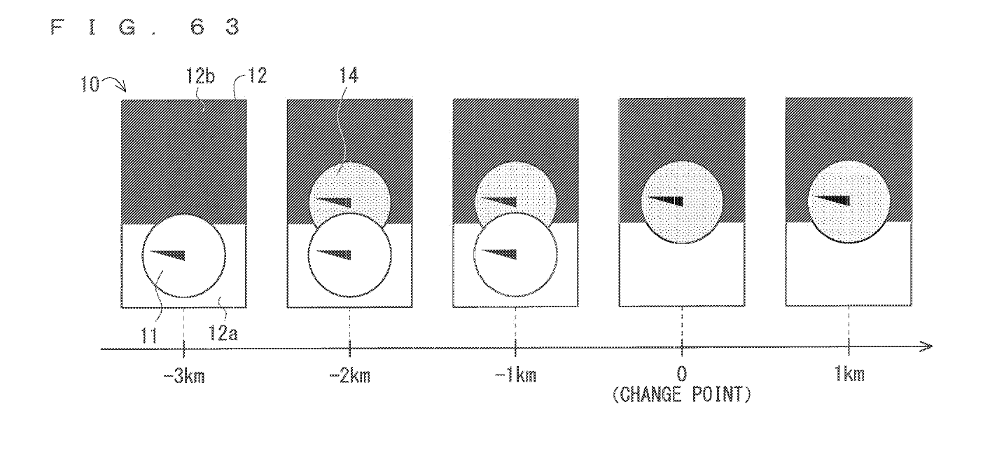

In the example shown in FIG. 62, the color of the second speedometer 14 deepens as the remaining distance decreases.

The example shown in FIG. 63 is similar to the example shown in FIG. 57. In particular, a notification of an expected overspeed is provided through the display manner (such as the color) of the second speedometer 14.

In the examples shown in FIGS. 57 to 63, the proximity information is the remaining distance to the change point. Alternatively, the proximity information may be the expected time required for arrival at the change point as in the example shown in FIG. 56. The examples in FIGS. 54 to 50 may be combined with the examples in FIGS. 60 to 63.

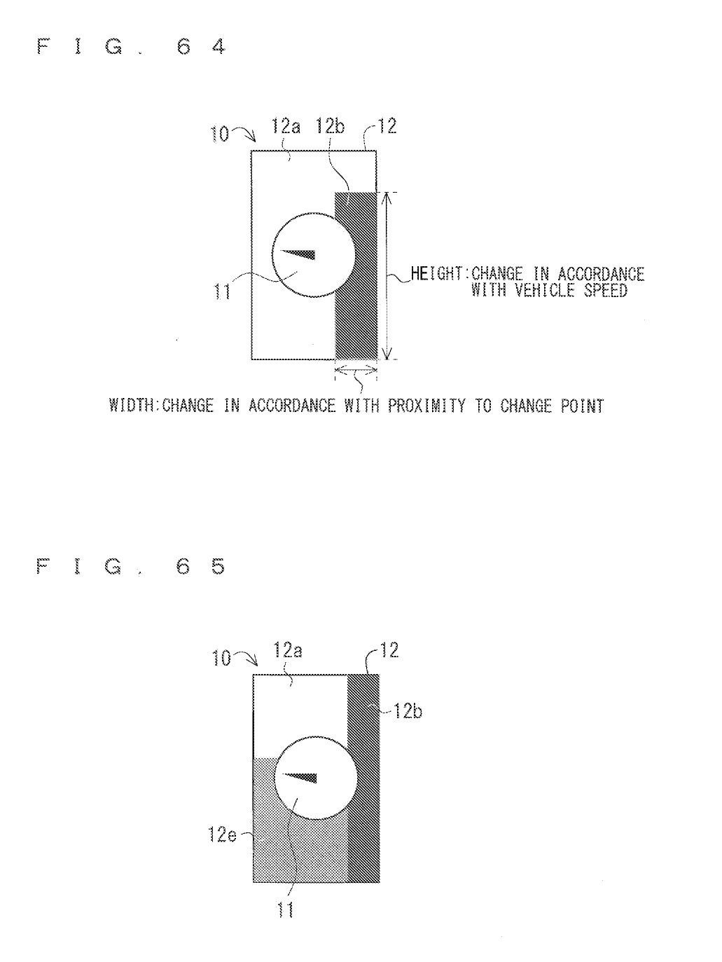

In the example shown in FIG. 64, the width of the notification region 12b is controlled in accordance with the proximity information, and the height of the notification region 12b is controlled in accordance with the vehicle speed as in the embodiment 1 and the like. In other words, the embodiment 12 is applicable to the notification regions 12b in the embodiments 1 to 11.

In the example shown in FIG. 65, the notification region 12b controlled in accordance with the proximity information is combined with a notification region 12e controlled as in the embodiment 1 and the like. For example, the notification regions 12b and 12e may have a step located therebetween or the stereoscopic display may be used such that the notification regions 12b and 12e can be easily distinguished from each other.

As is clear from the example in FIG. 65, the embodiment 12 may be combined with the embodiments 1 to 10. Alternatively, the embodiment 12 may be combined with the embodiment 11.

The embodiment 12 can produce the various effects described in the embodiments 1 to 10 with respect to the notification of changes in the path environment.

### Modifications

The above examples have been described assuming that the information display apparatuses 100 to 100D are vehicle-installed apparatuses. However, the information display apparatuses 100 to 100D are not always the vehicle-installed apparatuses. For example, the personal digital assistant (PDA) such as mobile phones, smart phones, and tablets may be provided as the information display apparatuses 100 to 100D. In this regard, the information display apparatuses 100 to 100D may be carried by various kinds of moving bodies (including not only vehicles but also humans).

Alternatively, the PDA may be provided as the information processing apparatuses 150 to 150D and the vehicle-installed display apparatuses may be provided as the display apparatuses 110 to 110F. If this is the case, the speedometer region 10 may be displayed on the display unit of the PDA as well.

Similarly, for example, the server configured to be capable of communicating with the display apparatuses 110 to 110F may be provided as the information processing apparatuses 150 to 150D.

Various functions of the information processing apparatuses 150 to 150D may be distributed among the constituent components of the system that incorporates a server and the like as appropriate.

In the present invention, the above embodiments can be arbitrarily combined, or each embodiment can be appropriately varied or omitted within the scope of the invention.

### EXPLANATION OF REFERENCE SIGNS

10 speedometer region, 11, 14 speedometer, 12 background region, 12a base region, 12b, 1261, 12b2, 12e notification region, 12b3 travel speed associated section, 12b4 speed limit associated section, 12b5 speed-related information associated section, 12b6 road-related information associated section, 12c, 12d intermediate region, 100, 100B to 100D information display apparatus, 110, 110B to 110F display apparatus, 111 screen, 121 actual speedometer apparatus, 122 image display apparatus, 123 half mirror, 124 background apparatus, 125, 126, 127 background member, 150, 150B to 150D information processing apparatus, 200 speed-related information acquiring unit, 201 travel speed information acquiring unit, 202 speed limit information acquiring unit, 210 controller, 211 image generating unit, 212 background controlling unit, 213 speedometer position controlling unit, 214 speedometer display manner controlling unit, 220 road-related information acquiring unit, 230 evaluation unit, 240 change point information acquiring unit, 250 proximity information acquiring unit, ST10, ST10B to ST10D operational flow, ST11 to ST19, ST01, ST02 processing step.

1-32. (canceled)

33. An information processing apparatus comprising:
a speed-related information acquirer to acquire, as speed-related information, information on a travel speed of a moving object or two pieces of information on said travel speed and on a speed limit for a road on which said moving object is located; and
a controller to control, in accordance with said speed-related information, a display manner of a speedometer region on a screen, said speedometer region including a speedometer that displays said travel speed and a background region being a region outside said speedometer, said background region including a base region and a notification region in which a color different from that of said base region is predominant.

34. The information processing apparatus according to claim 33, wherein said background region includes, between said notification region and said base region, at least one of:
a first intermediate region having a design that provides continuity across said base region side and said notification side through continuous changes; and
a second intermediate region having a design that is discontinuous on at least one of said base region side and said notification region side.

35. The information processing apparatus according to claim 33, wherein said controller controls, in accordance with said speed-related information, at least one of a dimension of said notification region in a predetermined direction, a display position of said speedometer in said background region, and a display manner of said speedometer.

36. The information processing apparatus according to claim 35, wherein
said notification region is a region for providing a notification to call attention to said travel speed, and
said controller increases the dimension of said notification region in said predetermined direction as said travel speed increases.

37. The information processing apparatus according to claim 36, wherein said predetermined direction of said notification region includes at least one of:
a direction in which, with said notification region not overlapping said speedometer on said screen, a gap between said notification region and said speedometer changes;
a direction in which, with said notification region overlapping part of said speedometer on said screen, an amount of an overlap between said notification region and said speedometer changes; and
a direction in which, with said notification region overlapping an entirety of said speedometer on said screen, said notification region is capable of changing its shape while overlapping the entirety of said speedometer.

38. The information processing apparatus according to claim 36, wherein the display position of said speedometer remains unchanged.

39. The information processing apparatus according to claim 36, wherein
said notification region includes a travel speed associated section and a speed limit associated section, and
said controller increases a dimension of said travel speed associated section in said predetermined direction as said travel speed increases, and controls a dimension of said speed limit associated section in said predetermined direction in accordance with said speed limit.

40. The information processing apparatus according to claim 33, further comprising a road-related information acquirer to acquire road-related information being information related to said road on which said moving object is located,
wherein said controller controls a display manner of said background region in accordance with said road-related information.

41. The information processing apparatus according to claim 35, wherein
said notification region is a region for providing a notification to call attention to said travel speed, and
said controller brings the display position of said speedometer closer toward a distant edge of said notification region located far from said base region as said travel speed increases.

42. The information processing apparatus according to claim 41, wherein said background region remains unchanged.

43. The information processing apparatus according to claim 35, wherein
said notification region is a region for providing a notification to call attention to said travel speed, and
said controller moves the display position of said speedometer away from a distant edge of said notification region located far from said base region as said speed limit increases.

44. The information processing apparatus according to claim 35, further comprising a road-related information acquirer to acquire road-related information being information related to said road on which said moving object is located, wherein
said notification region is a region for providing a notification to call attention to said travel speed, and
said controller controls at least one of the display position and the display manner of said speedometer in accordance with said road-related information.

45. The information processing apparatus according to claim 41, wherein said controller acquires information on which one of a plurality of preset speed ranges said travel speed belongs to and changes the display position of said speedometer at a position change rate set in advance for said speed range to which said travel speed belongs.

46. The information processing apparatus according to claim 45, wherein said controller changes a shape of said notification region discontinuously every time said speed range to which said travel speed belongs to is shifted.

47. The information processing apparatus according to claim 35, wherein said controller discontinuously changes at least one of the dimension of said notification region in said predetermined direction and the display position of said speedometer.

48. The information processing apparatus according to claim 35, wherein said controller continuously changes both the dimension of said notification region in said predetermined direction and the display position of said speedometer.

49. The information processing apparatus according to claim 33, wherein
said speed-related information acquirer includes a travel speed information acquirer to acquire information on said travel speed of said moving object,
said information processing apparatus further comprises an evaluator to acquire a travel-related evaluation by applying information on said travel speed acquired by said travel speed information acquirer to a travel-related evaluation rule defined in advance with said travel speed as an input parameter, and
said controller controls the display manner of said speedometer region on the screen in accordance with said travel-related evaluation.

50. An information display apparatus comprising:
the information processing apparatus according to claim 33; and
a display including said screen on which said speedometer region is displayed, said display being controlled by said information processing apparatus.

51. The information display apparatus according to claim 50, wherein
said display includes a structure that optically composes an image of said speedometer and an image of said background region to display a composed image on said screen, and
at least one of the image of said speedometer and the image of said background region is a projected image of an actual apparatus.

52. A display control method, comprising:
acquiring, as speed-related information, information on a travel speed of a moving object or two pieces of information on said travel speed and on a speed limit for a road on which said moving object is located; and
controlling, in accordance with said speed-related information, a display manner of a speedometer region on a screen, said speedometer region including a speedometer that displays said travel speed and a background region being a region outside said speedometer, said background region including a base region and a notification region in which a color different from that of said base region is predominant.
